(19) United States
(12) Patent Application Publication
(10) Pub. No.: US 2026/0187521 A1
(43) Pub. Date: Jul. 2, 2026

(54) FACILITATING EFFICIENT GENERATION OF EVALUATOR LOGIC USING ARTIFICIAL INTELLIGENCE

(71) Applicant: NVIDIA Corporation, Santa Clara, CA (US)

(72) Inventors: Mo HEKMAT, San Diego, CA (US); Wael ELHADDAD, Milpitas, CA (US); David Robert Auld, Saratoga, CA (US); Hesameddin MOHAMMADI, Santa Clara, CA (US); Philipp HERMANN, San Jose, CA (US); Allen Zeng QIN, Sunnyvale, CA (US); Paul IDZIKOWSKI, El Segundo, CA (US)

(21) Appl. No.: 19/003,212

(22) Filed: Dec. 27, 2024

(51) Int. Cl. G06N 20/00

(52) U.S. Cl. CPC G06N 20/00

(57) ABSTRACT

In various examples, systems and methods are disclosed related to facilitating management of evaluator logic. In particular, evaluator logic is generated in association with a requirement in an effective and efficient manner. To efficiently generate evaluator logic, artificial intelligence (AI) technology may be used to perform various aspects of the evaluator logic generation. In particular, a logical formula that represents the requirement may be generated using a temporal logic. The logical formula may then be used to generate, via one or more machine learning models, an evaluator logic in an executable format. In accordance with efficiently generating evaluator logic, the evaluator logic may be implemented to evaluate a product, a system, or other technology.

### BACKGROUND

Requirements are oftentimes created to articulate expected capabilities, features, and constraints of a product, system, and/or technology. In this regard, requirements may include specifications for a system's hardware and/or software components. As one example, vehicle level requirements (VLRs) may include specifications that define the essential functionalities, performance criteria, and/or safety standards a vehicle (e.g., a traditional combustion engine vehicle, electric vehicle, and/or autonomous vehicle) must meet. For example, VLRs may relate to safety standards, performance metrics (e.g., acceleration, braking, range, etc.), environmental standards, comfort and user experience, and/or autonomous-vehicle specific requirements (e.g., perception and planning, redundancy and safety, localization and mapping, etc.).

Requirements, such as VLRs, are often used to verify or test whether the actual system or product (e.g., an autonomous vehicle system) performs as expected. In this way, a system or product may be tested to determine or verify whether performance meets the specified requirements. For example, a software stack of an autonomous vehicle (AV) may be evaluated to determine whether it performs as expected under various conditions and scenarios (e.g., referenced in the requirements).

Requirements are generally initially expressed in human language. To evaluate a system, such as AV behavior, in association with a requirement, an initially expressed requirement is generally formalized into a representation that is suitable to use to evaluate or test performance against the requirement. For example, to evaluate a software stack of an AV in association with a particular requirement, an executable code is generally created by a programmer to evaluate performance of the software relative to the requirement.

In conventional implementations, to generate such an executable code, the programmer or other expert is intricately involved in manually identifying data (e.g., portions of logs) relevant to a requirement as well as generating the executable code that accurately analyzes data in accordance with the requirement. In addition, the evaluator code itself needs to be easily interpretable and as simple as possible compared to the software stack under test to ensure transparency, accuracy, and correctness. As such, developing code by a human(s) to analyze a system in association with a requirement is tedious and time consuming. Such a tedious and time-consuming task is exacerbated when developing executable code for an extensive number of requirements (e.g., VLRs). In particular, such manual coding is difficult to scale for AV evaluation. Further, such manual generation of executable code may result in erroneous analysis of a product, system, or technology in association with a requirement. Erroneously analyzing a product, system, or technology in association with a requirement may produce an undesired result and, in some cases, have a significant impact to users or others.

In addition, manual generation of executable code to analyze a system in association with a requirement may require significant utilization of programmer hours and computing resources over an extensive duration of time to develop and test the executable code. Further, erroneous generation of such executable code additionally consumes computing resources (e.g., to modify and re-evaluate the code), thereby resulting in unnecessary computing resource utilization of disk space, I/O operations, CPU and memory usage, and power consumption, among other things.

### SUMMARY

Embodiments of the present disclosure relate to facilitating efficient generation of evaluator logic used to evaluate a product, system, or technology in association with a requirement(s). Systems and methods are disclosed that perform development of evaluator logic in a simple and interpretable form based on an obtained requirement for a technology in an effective and efficient manner. To efficiently generate simple and interpretable evaluator logic, artificial intelligence (AI) technology may be used in conjunction with a signal temporal logic to perform various aspects of the evaluator logic generation. In particular, development of evaluator logic leverages temporal logic (e.g., STL). Using such temporal logic enables simplification of complex requirements into a clear and understandable logical formula, making them well-suited for use in automatically generating a corresponding evaluator logic. In this way, evaluator logic may be efficiently generated and/or analyzed.

In contrast to conventional implementations, facilitating generation of evaluator logic using AI technology (e.g., based on signal temporal logic) enables a more scalable, efficient, and effective development of evaluator logic, thereby enhancing evaluation of a product(s) and/or system(s). In addition to improved accuracy of product and/or system evaluations, computing resource utilization is reduced as less resources may be needed to develop and test executable code. Further, as a result of accurately identifying evaluator logic, unnecessary computing resource utilization that may otherwise be used to correct erroneously generated executable code resulting in utilization of disk space, I/O operations, CPU and memory usage, and power consumption, among other things, may be avoided.

### BRIEF DESCRIPTION OF THE DRAWINGS

The present systems and methods for facilitating efficient generation of evaluator logic used to evaluate a product, system, or technology in association with a requirement(s) are described in detail below with reference to the attached drawing figures, wherein:

FIG. 1 provides an example network environment, in accordance with some embodiments of the present disclosure;

FIG. 2 illustrates an example implementation for facilitating management of evaluator logic via evaluator manager, in accordance with embodiments described herein;

FIG. 3 provides an example for generating evaluator logic, in accordance with some embodiments of the present disclosure;

FIGS. 4A-4B provide an example for generating a logical formula, in accordance with some embodiments of the present disclosure;

FIG. 5 provides an example method for facilitating management of evaluator logic, in accordance with some embodiments of the present disclosure;

FIG. 6 provides an example method for facilitating management of evaluator logic, in accordance with some embodiments of the present disclosure;

FIG. 7 provides an example method for facilitating management of evaluator logic, in accordance with some embodiments of the present disclosure;

FIG. 8A is a block diagram of an example generative language model system suitable for use in implementing at least some embodiments of the present disclosure;

FIG. 8B is a block diagram of an example generative language model that includes a transformer encoder-decoder suitable for use in implementing at least some embodiments of the present disclosure;

FIG. 8C is a block diagram of an example generative language model that includes a decoder-only transformer architecture suitable for use in implementing at least some embodiments of the present disclosure;

FIG. 9 is a block diagram of an example computing device suitable for use in implementing at least some embodiments of the present disclosure; and

FIG. 10 is a block diagram of an example data center suitable for use in implementing at least some embodiments of the present disclosure.

### DETAILED DESCRIPTION

Systems and methods are disclosed related to facilitating management of evaluator logic. In particular, evaluator logic may be generated in association with a requirement, such as a VLR requirement, to facilitate analysis of a product, system, or technology in accordance with the requirement. A requirement may be any condition or capability that a product, system, or technology must meet or attain. Requirements may define the expected behavior, functionality, performance, and/or constraints that guide the design, development, and/or evaluation of a product, system, or technology. In some embodiments, a requirement is a VLR requirement. In this regard, the requirement may provide an expected behavior, functionality, performance, and/or constraints associated with an AV. Generally, evaluator logic may be generated for an obtained requirement (e.g., in the form of natural language). In particular, based on an obtained requirement, one or more logical predicates and operators/parameters may be identified and aggregated in a manner that logically formalizes the requirement. A temporal logic, such as STL, may be used to formalize the requirement into a logical formula. Using STL enables verification that a generated evaluator logic is simple and can easily translate to the target test requirement. The logical formula may then be used to generate a corresponding evaluator logic. The evaluator logic is generally generated in an executable code format. In this regard, in accordance with developing evaluator logic, the evaluator logic may thereafter be used to analyze a product, system, or technology in accordance with the corresponding requirement. Accordingly, performance and/or operation of a product, system, and/or technology may be evaluated or analyzed to verify conformity to a requirement or set of requirements associated with the product, system, and/or technology, or a portion thereof.

In implementation, embodiments described herein may perform generation and/or execution of evaluator logic. Evaluator logic generally represents software code that evaluates or analyzes whether particular data meets a particular requirement. For example, evaluator logic may include code that evaluates whether a system, product, or technology meets or attains a particular vehicle level requirement, thereby assessing the performance, safety, and/or reliability of an AV system, or portion thereof. In one embodiment, evaluator logic may be in the form of an executable programming language. For example, evaluator logic may be in a Python format. In some cases, an evaluator logic may correspond with a particular requirement. In this way, for each requirement, a corresponding evaluator logic may be generated. In other cases, an evaluator logic may correspond with multiple requirements. Advantageously, and in accordance with embodiments described herein, the evaluator logic may be automatically generated in an efficient and effective manner, resulting in a timely and accurate evaluator logic that is simple and easy to interpret and may be used for analyzing a product, system, or technology in association with a requirement.

In operation, to efficiently and effectively generate or develop evaluator logic in an automated manner, a requirement (e.g., in a natural language format) for which to generate an evaluator logic may be obtained. As described, a requirement may be associated with any type of product, system, and/or technology. The term technology may be used herein to generally refer to a product, system, software, hardware, component, or other type of technology corresponding with a requirement(s). In accordance with obtaining a requirement, to generate an evaluator logic, a set of logical predicates corresponding with a requirement for which evaluator logic is to be generated is identified. A logical predicate generally refers to a representation of a Boolean time series. A logical predicate may return or provide a truth value (e.g., representations of true or false values) based on input (e.g., input signals). In this regard, a logical predicate may return a binary result, as opposed to a continuous value, based on whether an input satisfies a condition. In other words, a logical predicate may be a representation of a Boolean condition applied to an input (e.g., a signal from a signal provider). In embodiments, a logical predicate is a truth value of a set of time series data.

In some cases, a logical predicate(s) may be derived or generated. As one example, a logical predicate may be generated or derived using or based on a signal provider. A signal provider may process input, such as raw data (e.g., time-varying or continuous signals), and produce a time series or some other derived output. Such output values may be numerical (non-Boolean) or Boolean. In this regard, a signal provider may be or include a function that takes raw data (e.g., sensor readings) as input, performs some processing or transformation, and then returns a result, which may be in the form of a time series or a sequence of values (or signals) that vary over time. In this way, a signal provider may abstract away data (e.g., the raw, unprocessed data) by applying some processing logic. A signal provider may perform various types of operations or functionalities, such as data filtering, mathematical operations (e.g., integration, differentiation, etc.), value returning based on conditions or thresholds, etc.

To generate a logical predicate using or based on a signal provider, a signal provider(s) may be identified. In particular, in embodiments, a signal provider(s) relevant to a requirement for which evaluator logic is being generated may be identified. For example, based on an obtained requirement, one or more signal providers corresponding with the requirement may be obtained from a data store. In some cases, a signal provider may be identified as relevant to a requirement based on analysis of the requirement. For example, for a requirement that references speed, one or more signal providers related to speed may be identified and obtained.

In one implementation, AI technology, such as a large language model (LLM), may be used to identify that a signal provider(s) is relevant to a particular requirement. For example, based on a prompt including a requirement, an LLM may provide, as output, one or more signal providers relevant to the requirement. In some cases, a response including a relevant signal provider(s) may be generated using the pre-trained knowledge or data of an LLM. In other cases, such a response may be generated using the pre-trained knowledge of the LLM as well as relevant data searched for and obtained via a data store (e.g., via a Retrieval-Augmented Generation (RAG) retrieval mechanism).

In some embodiments, a signal provider(s) may be generated and stored. A signal provider(s) may be generated in any of a number of ways. As one example, a signal provider may be automatically generated based on analysis of log data read (e.g., via a reader, such as an Autonomous Vehicle Metric Framework (AVMF) reader). For instance, data may be extracted from logs and, thereafter, used to identify or generate a corresponding signal provider. For example, assume a requirement includes an aspect related to jerk of a vehicle. In such a case, acceleration data in logs may be identified as relevant to jerk and, as such, used to generate a signal provider to represent jerk.

In accordance with identifying a signal provider(s) relevant to a requirement, the signal provider(s) may be used to generate a corresponding logical predicate. In some cases, a logical predicate may be generated in a manner that, when applied to output from a signal provider, results in output in a Boolean form. For example, for a signal provider for speed, a logical predicate may be generated that provides output indicating whether the speed exceeds a threshold speed (e.g., 2 miles per hour). To construct a logical predicate using or based on a signal provider, a logical or Boolean condition may be applied that transforms numerical or continuous values provided by a signal provider to Boolean or binary values. In this way, the logical predicate may include a logical condition or comparison applied to a signal(s) output from a signal provider that transforms numerical or continuous values of the signal provider into Boolean values, for example, a Boolean time series indicating whether the condition is met at each point in time.

Alternatively, or additionally, to generating logical predicates (e.g., via signal providers identified as relevant to a requirement), in some cases, logical predicates may be identified via logical predicates stored in a data store. In this regard, based on a requirement, a logical predicate(s) relevant to the requirement may be obtained from a data store. For example, a query or lookup approach may be used to identify one or more logical predicates relevant to a requirement. As another example, AI technology, such as an LLM, may be used to identify one or more logical predicates relevant to the requirement. For example, based on a prompt including a requirement, the LLM may provide, as output, one or more logical predicates relevant to the requirement. In some cases, a response including a relevant logical predicate(s) may be generated using the pre-trained knowledge or data of an LLM. In other cases, such a response may be generated using the pre-trained knowledge of the LLM as well as relevant data searched for and obtained via a data store (e.g., via a RAG retrieval mechanism).

Using one or more logical predicates, a logical formula based on signal temporal logic (STL), or an STL-based logical formula, may be generated in association with the requirement. A logical formula generally refers to an expression (e.g., formal expression) that includes logical predicates that represent variables, statements, or propositions and, in many cases, operators that combine or relate propositions to form a more complex formula. The logical predicate may be represented or denoted in any number of ways, one example of which includes letters representing a logical predicate. Operators may be any symbol or text that represents an operation or relationship. Operators may include logical operators, temporal operators, spatial operators, spatiotemporal operators, and/or relational operators (e.g., that are part of the STL language). Logical operators generally connect and/or modify propositions. Temporal operators generally incorporate or consider the change of propositions over time. In this regard, temporal operators enable a truth value of a proposition to change at different times. Spatial operators enable a geometric calculation of a proposition to change at different time. Spatiotemporal operators combine the time and space domains to enable a truth value of a spatiotemporal proposition. Relational operators that compare signal values (e.g., <, >, etc.) may also be used to generate a logical formula.

Based on a requirement, various logical predicates, operators, and/or parameters may be combined or aggregated in a manner that logically formalizes the requirement. Various types of logic may be used to formalize the requirement into a logical formula. For example, STL may be used. STL enables verification that a generated evaluator logic is simple and can easily translate to the target test requirement. For instance, without using STL, an arbitrary logic code may be generated that is tedious to analyze and manually verify its correctness. In this way, using STL in association with the logical formula enables a robust generation of the logical function, for example, via an LLM. Generally, STL may combine temporal operators with signals or continuous behaviors of time, thereby enabling expression of properties of signals that evolve over time (e.g., speed, temperature, etc.). In this regard, STL logical formulas may be constructed using logical operators and/or temporal operators with time bounds or parameters that restrict when certain conditions are evaluated or applied. As such, in embodiments, time parameters or other parameters may also be used to generate a logical formula (e.g., in addition to logical predicates and operators). In some embodiments, a parameter(s) may restrict or indicate when to apply certain conditions. As one example, a performance metric related to the timing of system responses may be used.

Operators and/or parameters may be identified for use in generating a logical formula in any number of ways. As one example, AI technology, such as an LLM, VLM, MMLM, etc. may be used to identify one or more operators and/or parameters relevant to a requirement. In other cases, an operator and/or parameter may be generated or identified based on analysis of the requirement (e.g., using AI technology or other technology).

In some cases, AI technology, such as an LLM, may be used to generate a logical formula. Input to the LLM may include, for example, a requirement, a set of logical predicates, a set of operators, a set of parameters an instruction to generate a logical formula, and/or the like. In this regard, a prompt may be generated that includes a requirement, a set of logical predicates, a set of operators, a set of parameters, and/or an instruction and, thereafter, provided as input to the LLM. In response, the LLM may return a logical formula that more formally represents a particular requirement.

Additionally or alternatively, AI technology, such as an LLM, may access a data store to generate a response. For instance, a prompt may include an instruction to generate a logical formula for a particular requirement. Various data, such as the logical predicates, operators, and/or parameters, may not be provided in the prompt. In this regard, an LLM may employ retrieval-augmented generation (RAG) to enable access to a data store including various logical predicates, signal providers, operators, and/or parameters to generate a response. In this way, a retrieval mechanism may be employed with the LLM to search and fetch relevant data from the data store, such as relevant logical predicates, operators, and/or parameters for use in generating a logical formula. As such, a generated response is prepared based on the pre-trained knowledge of the LLM and the retrieved data.

In accordance with generating a logical formula, evaluator logic may be generated in association with a requirement. As described, evaluator logic generally refers to logical structures or rules embedded to evaluate specific conditions or expressions to determine an outcome. In embodiments, evaluator logic may be in an executable format, such as Python. In this way, the evaluator logic may be executed (e.g., based on a call) to evaluate a product, system, or technology.

In embodiments, to generate evaluator logic, a logical formula associated with a requirement may be converted into an executable code format (e.g., Python). In this regard, a logical formula may be parsed and, thereafter, the parsed components may be mapped to expressions associated with the code format (e.g., Python) such that the logic may be implemented in an executable manner.

In some embodiments, AI technology, such as an LLM, may be used to generate evaluator logic for a requirement based on a logical formula. As one example, an LLM may interpret an input logical formula and identify various components of the logical formula (e.g., logical predicates, parameters, operators, etc.). Upon performing a mapping to the target coding language (e.g., Python), the evaluator logic may be created by the LLM, for example, by writing functions to evaluate conditions, creating loops to iterate over time intervals specified in logical formula, etc. Input to the LLM may include, for example, a requirement, a set of logical predicates, a set of operators, a set of parameters, a logical formula, a target coding language, an instruction to generate an evaluator logic, and/or the like. In this regard, in some cases, a prompt may be generated that includes a requirement, a set of logical predicates, a set of operators, a set of parameters, a logical formula, a target coding language, and/or an instruction. Thereafter, the prompt may be provided as input to the AI technology. In response, the AI technology may return evaluator logic that may be executed to evaluate or analyze a product, system, or technology in association with a particular requirement.

Additionally or alternatively, AI technology, such as an LLM, may access a data store to facilitate generation of a response. For instance, a prompt may include an instruction to generate an evaluator logic for a particular requirement. Further, such a prompt may include an identified logical formula and/or a target coding language for generating the evaluator logic. Various data, such as the logical predicates, operators, and/or parameters may not be provided in the prompt, but rather accessed via a data store (e.g., using RAG technique), as needed. As one example, a prompt may include the logical formula such that the evaluator logic may be generated therefrom and a target coding language in which to generate the evaluator logic. In some cases, a template may be accessed and used to generate the evaluator logic. For example, a template may be identified and included in a prompt for use in generating the evaluator logic. In response to the prompt, the AI technology may generate an evaluator logic for use in evaluating or analyzing a product, system, or technology.

In some cases, the AI technology, such as an LLM, may be used in an iterative manner to perform the various aspects. For example, an LLM may be fed a first prompt to identify relevant signal providers, a second prompt to identify relevant logical predicates, a third prompt to identify a logical formula, and a fourth prompt to generate evaluator logic, or any combination thereof. In other cases, an LLM may be used in a single implementation to perform the various aspects of the evaluator logic generation. In this regard, a single prompt may be generated and provided to an LLM to generate an evaluator logic. In such a case, the LLM may facilitate performance of the various aspects to generate the evaluator logic. The single prompt may be configured to include various types of data. In one example, the prompt may include a requirement and a request to generate an evaluator logic. In this regard, the LLM can convert or transform the requirement (e.g., in a natural language format) to an executable evaluator logic, as described herein. In such a case, additional data used to generate the evaluator logic may be obtained via an embedded search (e.g., logical predicates, signal providers, operators, parameters, etc.). In another example, the prompt may additionally include various additional types of data, such as signal providers, operators, parameters, logical predicates, etc.

In some embodiments, generated evaluator logic may be analyzed. As can be appreciated, analyzing evaluator logic generally facilitates verification and/or validation of an effective or accurate evaluator logic. In some cases, to analyze the evaluator logic, evaluation results may be generated using the evaluator logic. For example, log data, and other applicable data, may be used to analyze an evaluator logic. The evaluation results can then facilitate assessment of the quality or accuracy of the evaluation results. In other cases, to analyze the evaluator logic, a prompt requesting assessment of the quality or accuracy of the evaluator logic may be generated and input into the AI technology, such as an LLM. In response, an analysis of the evaluator logic may be provided. In some examples, the evaluator logic analysis may be provided, for example, for display to a user device. In such a case, the user may elect to confirm or deny subsequent use of the evaluator logic.

As another example, via an input tool at a user device, a user may provide an input with an instruction or request to provide shortcomings or issues of an evaluator logic, provide a quality assessment of an evaluator logic, and/or the like. A prompt may be generated based on the input and the evaluator logic. The AI technology may then provide a response, which may then be further analyzed, used to enhance the previously generated evaluator logic, and/or provided for display (e.g., to a user via a user device).

Upon generating and/or verifying an evaluator logic, the evaluator logic may be used to analyze or evaluate a product, system, and/or technology. Analysis of a product, system, and/or technology may be implemented in any number of environments. For example, a product, system, and/or technology (e.g., AV system, or portion thereof) may be analyzed in connection with a requirement(s) during product development, verification, validation, and/or implementation.

Analyzing a product, system, and/or technology using an evaluator logic(s) may be initiated in any of a number of ways. As one example, a user of a user device (e.g., a product developer) may select to execute or run a particular evaluator logic to evaluate a particular product in association with a requirement. For instance, a user may select or input to evaluate a particular product in association with a particular requirement.

As another example, a user of a user device may select to execute or run a test to analyze a particular product. A test generally refers to a procedure or process used to evaluate the functionality, performance, or behavior of a product, system, and/or technology. A test may be used to verify various requirements are attained. In this way, a test facilitates identification of issues, ensures reliability, and/or validates that the product, system, or technology operates as intended. A test may include a coverage plan that specifies conditions or manners in which to execute a test. For example, for an AV coverage plan, the test may include driving conditions, different road scenarios, times and durations, etc. A test may correspond with any number of requirements. For instance, for a test to ensure AV safety, various requirements may need to be met in the various testing conditions.

To analyze a product, system, and/or technology in association with a requirement, a representation of data to be analyzed in association with a requirement may be obtained. The data representation may be any type of data associated with a requirement. For example, for VLR requirements, AV data may be obtained. In embodiments, the data may be observed data (e.g., via an actual or real drive process) or simulated data. In this way, performance or operation of a product, system, or technology may be analyzed in relation to a requirement with actual observed data or, alternatively or additionally, with simulated data or synthetic data.

In some cases, the representation of data may be in the form of log data. In other cases, the representation of data may be in the form of an output generated via a signal provider(s) and/or logical predicate(s). For instance, the representation of data may be or include a time series dataset based on application of a signal provider(s) and/or logical predicate(s) to log data (e.g., observed log data and/or simulated log data). By way of example only, a signal provider may obtain log data by way of a reader. The signal provider may perform a corresponding processing of the log data to generate a signal that is obtained.

In accordance with initiating analysis of a product, system, and/or technology in relation to a requirement(s), the evaluator logic(s) may be referenced or called to execute the evaluator logic(s). In this way, the evaluator logic(s) may execute the logical formula, given a set of signal providers, logical predicates, and/or parameters, to produce an evaluation result. In executing the evaluator logic(s), the evaluator logic may reference, access, or fetch various types of data to perform the evaluation. For example, the evaluator logic may reference log data, signal providers, signals generated from signal providers, logical predicates, operators, parameters, logical formulas, and/or the like.

The evaluation results generated based on execution of the evaluator logic may be represented in any form. As one example, a pass or fail result may be represented (e.g., via text, numerals, symbols, etc.) in association with a corresponding requirement. In some cases, the evaluation results may correspond with an event. An event may correspond with a particular set of data. For example, for one set of log data associated with a particular AV, an evaluation result may be generated for the event.

Evaluation results may be provided in any of a number of ways. As one example, an evaluation result may be presented for each event. In another example, a set of events identified as meeting the requirement may be presented and a separate set of events identified as failing the requirement may be presented. By way of example only, depending on a requirement being evaluated in association with a product, system, or technology, evaluation results may indicate or specify whether the data indicates a system (e.g., an AV system) is safe, whether an AV system will perform suitably if a pedestrian jumps in front, whether an AV system will reduce its speed if another vehicle on the path begins decelerating, etc. In this way, the evaluation results facilitate evaluation of a product, system, or technology to ensure or verify the technology operates as intended or desired.

Advantageously, generating evaluator logic using AI enables a more effective and efficient evaluation logic generation, thereby increasing accuracy and efficiency of performing evaluation of products, systems, and/or technologies. Further, using STL provides a more transparent approach that enables simple and effective verification. In this regard, generation of evaluator logic based on STL and facilitated via AI enables an effective, efficient, and transparent approach to verification of requirements. In addition to improved accuracy of technology evaluations, computing resource utilization is reduced as less resources may be needed to develop and test executable code. Further, as a result of accurately identifying evaluator logic, unnecessary computing resource utilization that may otherwise be used to correct erroneously generated executable code resulting in utilization of disk space, I/O operations, CPU and memory usage, and power consumption, among other things, may be avoided.

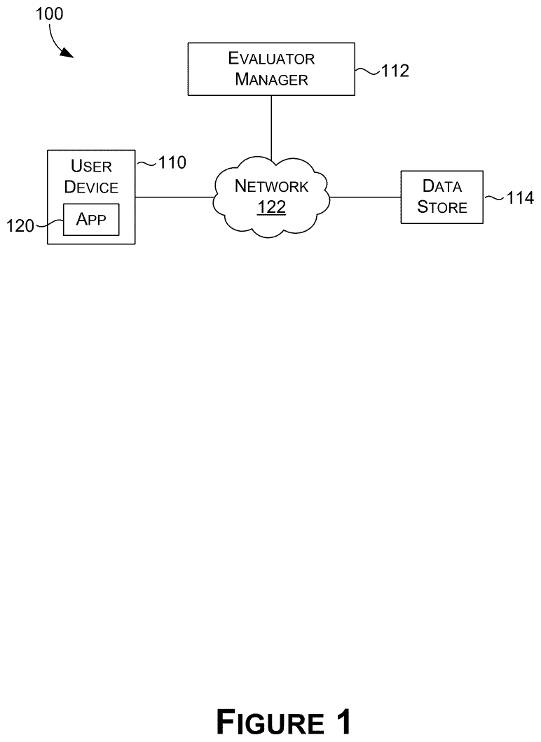

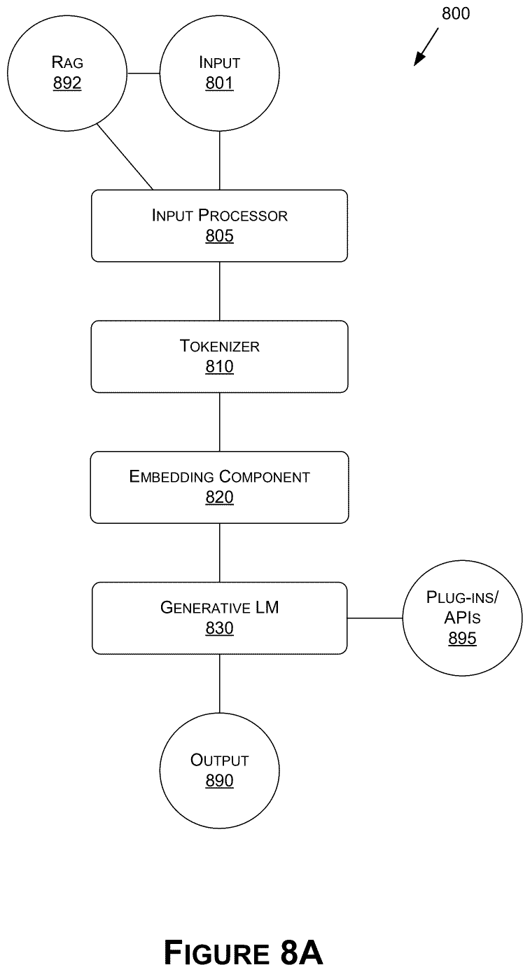

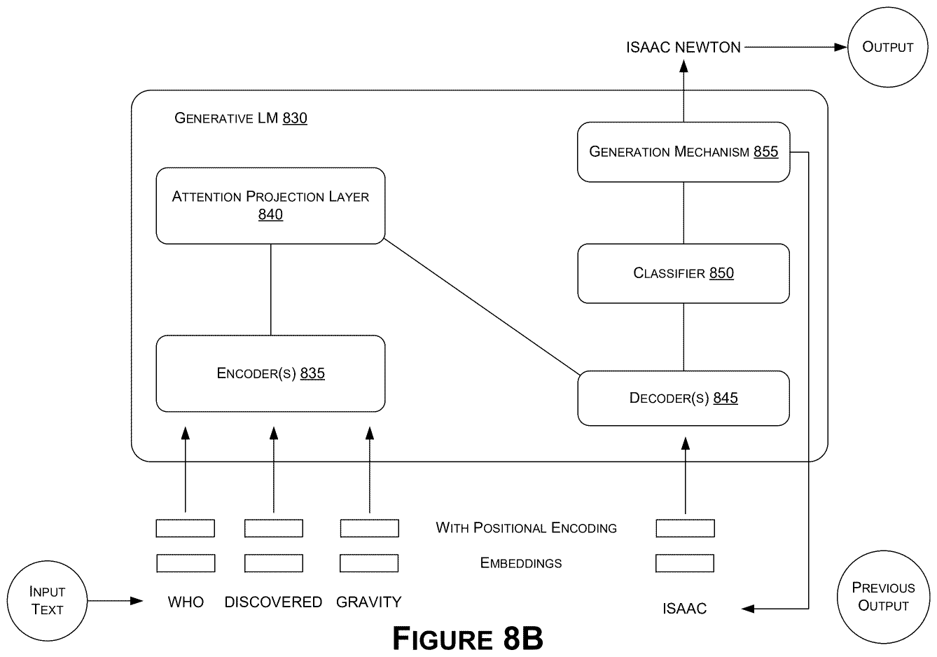

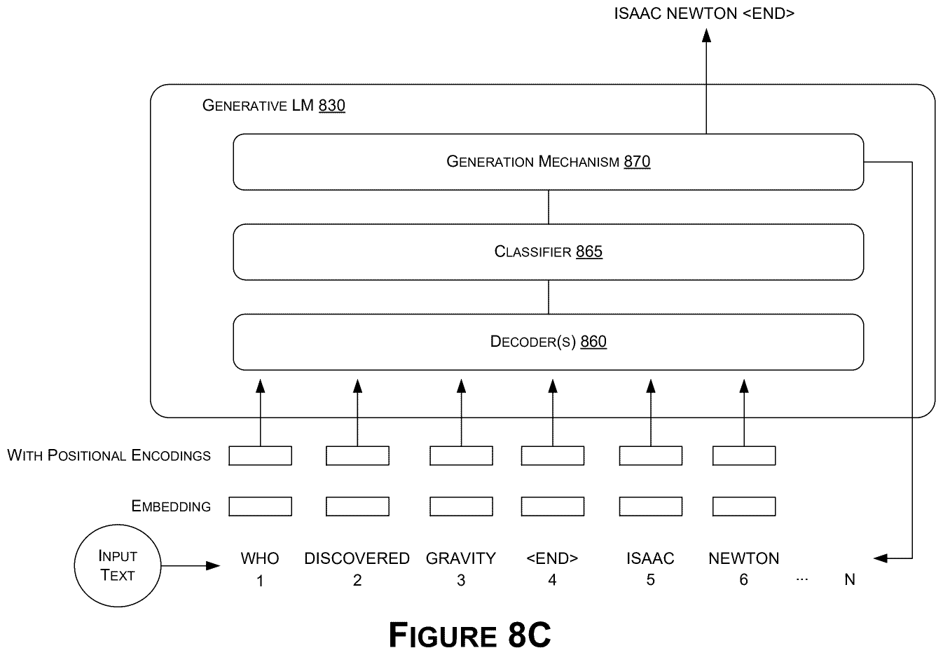

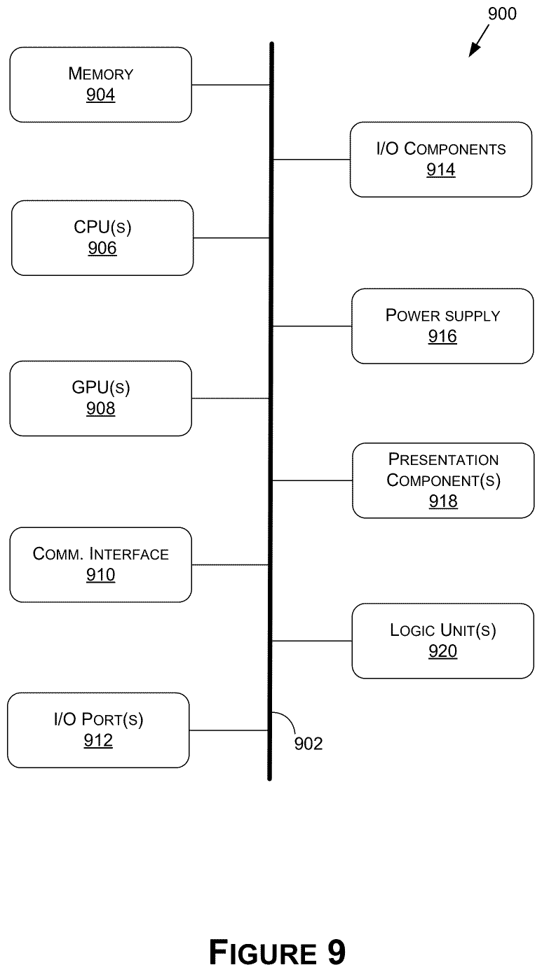

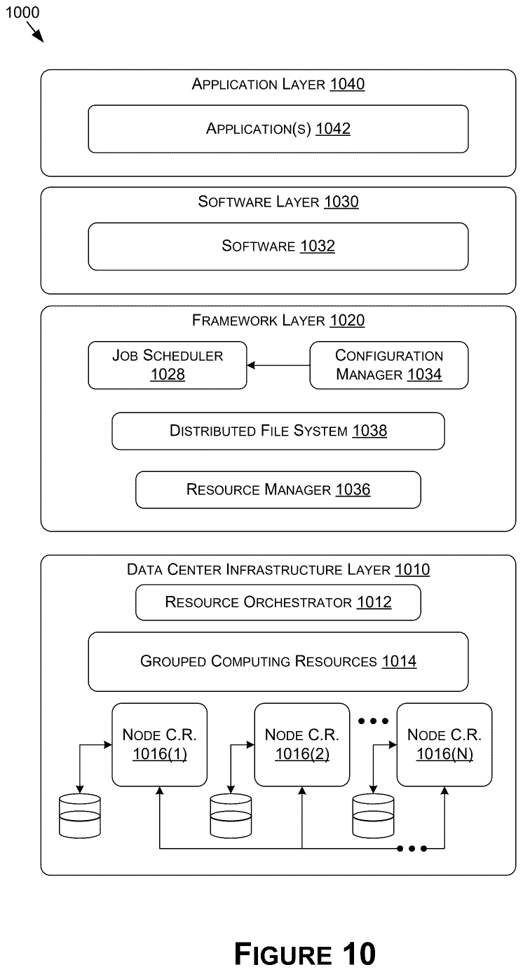

With reference to FIG. 1, FIG. 1 is an example network environment, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 8A-8C), one or more computing devices or components thereof (e.g., as described in FIG. 9), and/or one or more data centers or components thereof (e.g., as described in FIG. 10).

With continued reference to FIG. 1, a block diagram of an exemplary network environment 100 suitable for use in implementing embodiments described herein is shown. Generally, the system 100 illustrates an environment suitable for facilitating management of evaluator logic. Among other things, embodiments described herein effectively and efficiently generate evaluator logic in association with a requirement, such as a VLR requirement, to facilitate analysis of a product, system, or technology in accordance with the requirement. In accordance with embodiments described herein, AI technology, such as LLMs, may be used to perform aspects of the evaluator logic generation in an automated manner.

The network environment 100 includes a user device 110, an evaluation manager 112, and a data store 114. The user device 110, the evaluation manager 112, and the data store 114, can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. For example, the user device may be in communication with the evaluation manager 112 via a mobile network or the Internet, and the evaluation manager 112 may be in communication with data store 114 via a local area network. Further, although the environment 100 is illustrated with a network, one or more of the components may directly communicate with one another, for example, via HDMI (high-definition multimedia interface) and DVI (digital visual interface). Alternatively, one or more components may be integrated with one another. For example, at least a portion of the evaluation manager 112 and/or data store 114 may be integrated with the user device 110. For instance, a portion of the evaluation manager 112 may be integrated with a server in communication with a user device 110, while another portion of the evaluation manager 112 may be integrated with the user device 110.

The user device 110 can be any kind of computing device capable of facilitating efficient and effective generation and/or execution of evaluator logic. For example, in an embodiment, the user device 110 can be a computing device such as computing device 900, as described above with reference to FIG. 9. In embodiments, the user device 110 can be a personal computer (PC), a laptop computer, a workstation, a mobile computing device, a personal digital assistant (PDA), a cell phone, or the like.

The user device 110 may include one or more processors and one or more computer-readable media. The computer-readable media may include computer-readable instructions executable by the one or more processors. The instructions may be embodied by one or more applications, such as application 120 shown in FIG. 1. The application(s) may generally be any application capable of facilitating efficient and effective generation and/or execution of evaluator logic. In some cases, the application(s), such as application 120, may facilitate automated management of evaluator logic. In some implementations, the application(s) comprises a web application, which can run in a web browser, and could be hosted at least partially server-side (e.g., via evaluation manager 112). In addition, or instead, the application(s) may comprise a dedicated application. In some cases, the application is integrated into the operating system (e.g., as a service). As one specific example application, application 120 may be a code development or management tool, or a portion thereof, that enables creation, management, and/or delivery of code. Application 120 may be accessed via a mobile application, a web application, or the like.

User device 110 may be a client device on a client-side of operating environment 100, while evaluation manager 112 may be on a server-side of operating environment 100. Evaluation manager 112 may comprise server-side software designed to work in conjunction with client-side software on user device 110 so as to implement any combination of the features and functionalities discussed in the present disclosure. An example of such client-side software is application 120 on user device 110. This division of operating environment 100 is provided to illustrate one example of a suitable environment, and it is noted there is no requirement for each implementation that any combination of user device 110 and evaluation manager 112 to remain as separate entities.

In an embodiment, the user device 110 is separate and distinct from the evaluation manager 112 and the data store 114 illustrated in FIG. 1. In another embodiment, the user device 110 is integrated with one or more illustrated components. For instance, the user device 110 may incorporate functionality described in relation to the evaluation manager 112. For clarity of explanation, embodiments are described herein in which the user device 110, the evaluation manager 112, and the data store 114 are separate, while understanding that this may not be the case in various configurations contemplated.

As described, a user device, such as user device 110, may facilitate automated management of evaluator logic. In particular, the user device 110 may facilitate the evaluation manager 112 obtaining a requirement and, in response, provide a view of an indication or representation of an evaluator logic generated in association with the requirement. A user device 110, as described herein, may be operated by an individual or set of individuals that desire to initiate evaluator logic generation and/or view results in association therewith. In some cases, the user device 110 may be operated by a code developer or manager. Alternatively or additionally, the user device 110 may be operated by an individual affiliated with the code that desires to evaluate a technology, such as a product or system.

In some cases, evaluator logic generation may be initiated at the user device 110. In this regard, a user may provide or select a requirement for use in generating evaluator logic to evaluate a technology. For example, a user, such as a software product developer, may input, provide, or select various requirements for use in generating evaluator logic. For instance, a user may input or select, via a user interface, a VLR. In some cases, a user may navigate to and select a VLR for use in generating evaluator logic. As another example, a user may select one or more requirements based on a list of products or systems displayed via the user device (e.g., a list of different products may be presented for selection). Requirements may be in any of a number of formats, which may vary depending on the type of requirement. In embodiments, a requirement may be text in the form of natural language.

An input or selection of a requirement(s) may be provided via an application 120 operating on the user device 110. In this regard, the user device 110, via an application 120, might allow a user to input, select, or otherwise provide a requirement, such as a VLR. The application 120 may facilitate the inputting of requirements in a verbal form, a textual input form, a document form, an image form, etc. Such requirements may be input at the user device 110 in any manner. For instance, upon accessing a particular application (e.g., a code development and/or management application), a user may be presented with, or navigate to, an input tool to input or select various requirements desired for use in generating evaluator logic.

In accordance with generating evaluator logic, a representation of a generated evaluator logic may be presented to the user via the application 120 operating on the user device 110. In this way, evaluator logic identified via the evaluator manager may be displayed to an individual or entity desiring to view possible evaluator logic in association with a requirement(s). In some cases, the application 120 may enable the user to modify the evaluator logic for use in evaluating technology.

The user device 110 can communicate with the evaluation manager 112 to provide a requirement, or an indication thereof, and/or obtain a representation of an evaluator logic. In embodiments, for example, a user may utilize the user device 110 to provide a requirement via the network 122. For instance, in some embodiments, the network 122 might be the Internet, and the user device 110 interacts with the evaluator manager 112 to provide a requirement for use in generating evaluator logic. In other embodiments, for example, the network 122 might be an enterprise network associated with an organization. It should be apparent to those having skill in the relevant arts that any number of other implementation scenarios may be possible as well.

With continued reference to FIG. 1, the evaluator manager 112 can be implemented as server systems, program modules, virtual machines, components of a server or servers, networks, and the like. At a high level, the evaluator manager 112 manages generation and/or utilization of evaluator logic. In particular, evaluator logic may be generated in association with a requirement, such as a VLR requirement. To generate evaluator logic, embodiments described herein may identify a logical predicate(s) associated with the requirement and determine a logical formula (e.g., in STL form) using such a logical predicate(s). AI technology, such as an LLM, may be used to facilitate any of a variety of aspects of evaluator logic generation. As one example, an LLM may be used to take a requirement as input and provide, as output, evaluator logic. As another example, an LLM may take a logical formula as input and provide, as output, evaluator logic. As such, the evaluator logic may be automatically generated in an efficient and effective manner, resulting in a timely and accurate evaluator logic based on STL framework that is transparent and easy to interpret and may be used for analyzing a product, system, or technology in association with a requirement.

Advantageously, the evaluator logic is generally generated in an executable code format. In this regard, in accordance with generating an evaluator logic, the evaluator logic may be executed to analyze a product, system, or technology in accordance with the corresponding requirement. Accordingly, performance and/or operation of a product, system, and/or technology may be evaluated or analyzed to verify conformity to a requirement or set of requirements associated with the product, system, and/or technology, or a portion thereof.

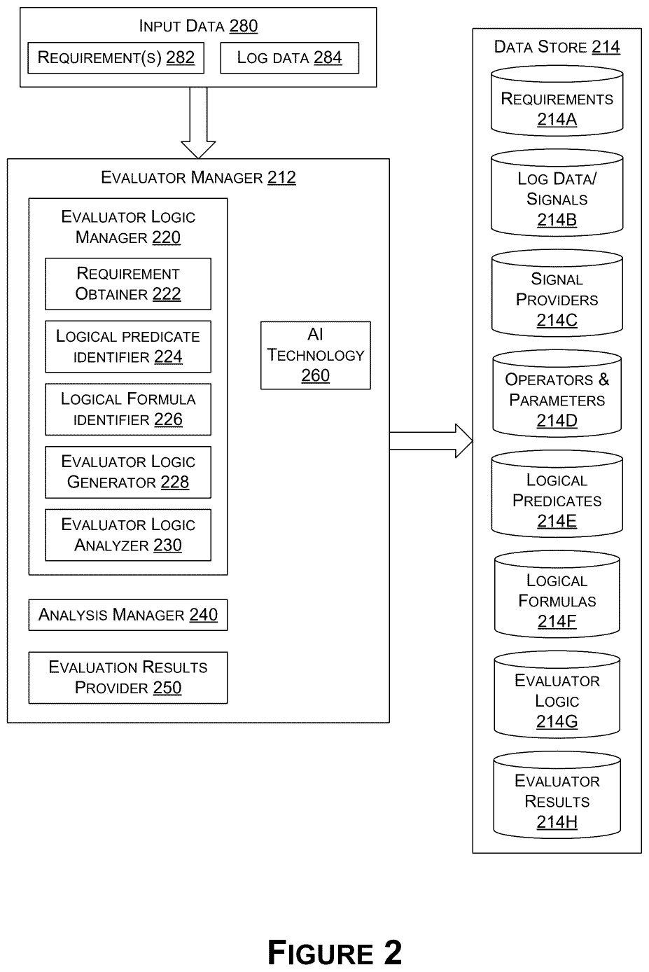

Turning now to FIG. 2, FIG. 2 illustrates an example implementation for facilitating management of evaluator logic via evaluator manager 212. In operation, the evaluator manager 212 is generally configured to manage generation and/or utilization of evaluator logic. In particular, evaluator manager 212 manages generating evaluator logic in association with a requirement, such as a VLR requirement. To this end, evaluator logic may be generated for a requirement based on an input requirement (e.g., in the form of natural language). Advantageously, and in accordance with embodiments described herein, the evaluator logic may be automatically generated in an efficient and effective manner, resulting in a timely and accurate evaluator logic that may be used for analyzing a product, system, or technology in association with a requirement. The evaluator logic is generally generated in an executable code format. In this regard, in accordance with generating an evaluator logic, the evaluator logic may be executed to analyze a product, system, or technology in accordance with the corresponding requirement. Accordingly, performance and/or operation of a product, system, and/or technology may be evaluated or analyzed to verify conformity to a requirement or set of requirements associated with the product, system, and/or technology, or a portion thereof.

The evaluation manager 212 can communicate with the data store 214. The data store 214 is configured to store various types of information accessible by the evaluator manager 212, or other server or component. In embodiments, evaluator manager 212 and user device(s) (such as user device 110 of FIG. 1) can provide data to the data store 214 for storage, which may be retrieved or referenced by any such component. As such, the data store 214 may store various types of data, such as requirements, log data, signals, signal providers, operators, parameters, logical predicates, logical formulas, evaluator logic, evaluation results, or combinations thereof or representations thereof.

To effectively and efficiently generate evaluator logic, the evaluator manager 212 may include or communicate with AI technology 260. AI technology 260 may include any type of AI technology that may be used to implement various aspects associated with the evaluator manager 212, some aspects of which are described more fully herein. In some embodiments, AI technology 260 is, or includes, an LLM. Although AI technology 260 is illustrated as incorporated with the evaluator manager 212, the AI technology 260 may be separate or distinct from the evaluator manager 212 (e.g., as a separate service or incorporated with another system or component) or may be incorporated with another component (e.g., evaluator logic manager 220).

In embodiments, AI technology may include or access any number of AI models or technologies. As one example, a machine learning model in the form of an LLM may be used to generate evaluator logic. A language model is a statistical and probabilistic tool that determines the probability of a given sequence of words occurring in a sentence (e.g., via next sentence prediction [NSP] or masked language model [MLM]). Simply put, it is a tool that is trained to predict the next word in a sentence. A language model is called a large language model (LLM) when it is trained on an enormous amount of data. In particular, an LLM refers to a language model including a neural network with an extensive amount of parameters that is trained on an extensive quantity of unlabeled text using self-supervising learning. Oftentimes, LLMs have a parameter count in the billions, or higher. Some examples of LLMs are GOOGLE's BERT and OpenAI's GPT-2, GPT-3, and GPT-4. For instance, GPT-3 is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. Although some examples provided herein include a single-mode generative model, other models, such as multimodal generative models, are contemplated within the scope of embodiments described herein. Generally, multimodal models are generated to make predictions based on different types of modalities (e.g., text and images). In some embodiments, AI technology 260 takes on the form of or uses an LLM, but various other artificial intelligence models or technologies can additionally or alternatively be used. Other models or technology may be used herein, including, but not limited to small language models.

In embodiments, the evaluation manager 212 includes an evaluator logic manager 220, an analysis manager 240, an evaluation results provider 250, and AI technology 260. According to embodiments described herein, the evaluator manager 212 can include any number of other components not illustrated. In some embodiments, one or more of the illustrated components 220, 230, 240, 250, and 260 can be integrated into a single component or can be divided into a number of different components. Components 220, 230, 240, 250, and 260 can be implemented on any number of machines and can be integrated, as desired, with any number of other functionalities or services.

The evaluator logic manager 220 is generally configured to manage generation of evaluator logic(s) associated with a requirement(s). As described herein, evaluator logic generally represents software code that evaluates or analyzes whether particular data meets a particular requirement. For example, evaluator logic may include code that evaluates whether a system, product, or technology meets or attains a particular vehicle level requirement, thereby assessing the performance, safety, and/or reliability of an AV system, or portion thereof. In some cases, evaluating or analyzing whether a system, product, or technology meets or attains a particular requirement, such as a vehicle level requirement, may be determined using log data (e.g., from an AV or a simulation).

To generate evaluator logic(s), the evaluator logic manager 220 may communicate with data store 214. The data store 214 may include various types of data that may be accessed to generate evaluator logic. By way of example only, the data store 214 may store requirements 214A, log data and/or signals 214B, signal providers 214C, operators and/or parameters 214D, logical predicates 214E, logical formulas 214F, evaluator logic 214G, evaluator results 214H, and/or the like. Such types of data is not intended to be limited herein. Further, any type or number of data structures may be used to store the data. The separation of data illustrated in FIG. 2 is provided only for purposes of explanation.

To generate evaluator logic, the evaluator logic manager 220 may include various components. In embodiments, the evaluator logic manager 220 includes a requirement obtainer 222, a logical predicate identifier 224, a logical formula identifier 226, an evaluator logic generator 228, and an evaluator logic analyzer 230. According to embodiments described herein, the evaluator logic manager 220 can include any number of other components not illustrated. In some embodiments, one or more of the illustrated components 222, 224, 226, 228, and 230 can be integrated into a single component or can be divided into a number of different components. Components 222, 224, 226, 228, and 230 can be implemented on any number of machines and can be integrated, as desired, with any number of other functionalities or services.

As described, evaluator logic refers to logic used to evaluate or analyze a product, system, or technology against a requirement, such as a VLR. Evaluator logic may be in any number of formats that provide a structured framework for making deductions, inferences, and/or evaluations based on a given set of inputs (e.g., log data or derivations or representations thereof). In one embodiment, evaluator logic may be in the form of an executable programming language. For example, evaluator logic may be in a Python format. In some cases, an evaluator logic may correspond with a particular requirement. In this way, for each requirement, a corresponding evaluator logic may be generated. In other cases, an evaluator logic may correspond with multiple requirements.

Evaluator logic generation may be initiated in any number of ways. In some cases, evaluator logic generation may be initiated to generate evaluator logic, in association with a requirement or set of requirements, for subsequent use (e.g., in association with analyzing satisfaction of a requirement using the evaluator logic). As one example, a user may select (e.g., via a user interface) to generate evaluator logic for a particular requirement. For instance, a user may input a requirement via a user device and, in association therewith, select to generate evaluator logic for the requirement. As another example, a user may select to generate evaluator logics for various requirements associated with a product, service, or technology. In this regard, a user may input, via a user interface of a user device, a set of requirements and, in association therewith, select to generate an evaluator logic for each requirement. By way of example only, assume five requirements are associated with a particular technology. In accordance with providing the five requirements, a user may select to generate evaluator logic for each of the five requirements. Alternatively, evaluator logic generation may be initiated automatically or based on an occurrence of an event. For instance, upon obtaining input of a requirement, evaluator logic generation for the particular requirement may be automatically initiated. Generated evaluator logic may be stored in a data store, such as evaluator logic 214G in data store 214, for subsequent use (e.g., in association with implementing an evaluation of a product, system, or technology).

In other cases, evaluator logic generation may be initiated in association with initiating evaluation of a product, system, or technology. In this regard, in accordance with initiating evaluation or analysis to detect whether a product, system, or technology meets a requirement(s) (e.g., VLR requirement(s)), an evaluator logic(s) for the corresponding requirement(s) may be generated and subsequently executed. In this way, initiating generation and execution of an evaluator logic may be triggered in accordance with a single event (e.g., selection, command, or input). By way of example only, assume a user selects, via a user interface of a user device, to evaluate a product in association with a particular requirement (e.g., VLR requirement). In such a case, a corresponding evaluator logic may be generated in association with the requirement and, thereafter, executed to evaluate the product with regard to the requirement.

The requirement obtainer 222 is generally configured to obtain requirements, such as requirement(s) 282 of input data 280, or a representation(s) thereof. As described, a requirement may be any condition or capability that a product, system, or technology must meet. Requirements may define the expected behavior, functionality, performance, and/or constraints that guide the design, development, and/or evaluation of a product, system, or technology. In this regard, a requirement may be a hardware or software requirement associated with a product, system, or technology that requires a requirement-based verification.

In some cases, a requirement(s) may be obtained via a user interface. For example, a user (e.g., a product developer) may provide a requirement via a user interface of a user device using text or voice input to specify the requirement. Additionally or alternatively, a requirement(s) may be obtained via a data store. For example, based on a user input (e.g., a selection of a requirement) or an occurrence of an event (e.g., a lapse of a time duration), a requirement may be obtained via requirements 214A of data store 214.

Various types of requirements may exist. As one example, a requirement may be a functional requirement that specifies what the system, product, or technology should perform. A functional requirement may specify features, capabilities, or services to provide. As another example, a requirement may be a non-functional requirement that specifies how the system should behave. For instance, a requirement may specify performance, usability, reliability, scalability, security, etc. As another example, a requirement may be a technical requirement that defines technical specifications or constraints, for example, related to hardware, software, and/or network architecture. As yet another example, a requirement may be a regulatory requirement that provides conditions to be met to comply with a law, regulation, or standard. Such example types of requirements are not intended to be limited herein.

A requirement(s) may be provided in any number of formats. In some cases, a requirement may be provided in a natural language format. In this regard, an individual(s) (e.g., a product developer) may input or provide a requirement for a product, system, or technology. For example, an input VLR requirement may be “CPM brake intervention in standstill hold shall end when the gear is shifted from the current position to P (parking).”

Any number of requirements may be obtained for a product, system, or technology. In some cases, a particular requirement may be obtained. As one example, a specific requirement may be input by a user via a user interface. As another example, a specific requirement may be obtained from a data store, such as data store 214, for instance, based on a user selection of the requirement (e.g., via a user interface). In other cases, a set of requirements may be obtained. For example, in association with a product, system, or technology to evaluate, corresponding requirements may be obtained. For instance, assume a user selects a representation of a particular product to evaluate. In such a case, requirements associated with the product may be obtained (e.g., from a data store) such that corresponding evaluator logics may be generated.

In embodiments, requirement(s) 282 obtained as input data 280 may be stored in the data store 214. In this way, the requirement(s) may be subsequently accessed and used for subsequent generation and/or execution of evaluator logic(s).

The logical predicate identifier 224 is generally configured to identify logical predicates. In particular, in embodiments, the logical predicate identifier 224 identifies logical predicates relevant to a requirement for which evaluator logic is to be generated. A logical predicate generally refers to a representation of a Boolean timeseries. A logical predicate may be a statement or condition that returns or provides a truth value (e.g., true or false) based on input (e.g., input signals). In this regard, a logical predicate may return a binary result, as opposed to a continuous value, based on whether an input satisfies a condition. In other words, a logical predicate may provide a Boolean condition applied to an input (e.g., a signal from a signal provider).

In some cases, the logical predicate identifier 224 may derive or generate logical predicates. As one example, a logical predicate may be generated or derived using or based on a signal provider. A signal provider may refer to a function that processes input, such as raw data (e.g., time-varying or continuous signals), and produces a time series or some other derived output or signal. Such output or signal may be numerical (non-Boolean) or Boolean. In this regard, a signal provider may take raw data (e.g., sensor readings) and parameters as input, perform some processing or transformation, and then return a result, which may be in the form of a time series or a sequence of values (or signals) that vary over time. In this way, a signal provider may abstract away data (e.g., the raw, unprocessed data) by applying some processing logic. A signal provider may perform various types of operations or functionalities, such as data filtering, mathematical operations (e.g., integration, differentiation, etc.), value returning based on conditions or thresholds, etc. By way of example only, assume an input is raw acceleration data a(t). A signal provider, for example in the form of a function, may be a derivative function that calculates the rate of change of acceleration, thereby outputting a jerk value.

In some cases, a signal provider may be a logical predicate that outputs a Boolean time series dataset. For example, a signal provider that returns true or false, or provides Boolean output, may also be referred to as a logical predicate. As such, in some cases, the logical predicate identifier 224 may identify a signal provider(s) that results in Boolean output. In other cases, the logical predicate identifier 224 may identify a signal provider, which may then be used to generate a logical predicate.

To generate a logical predicate using or based on a signal provider, the logical predicate identifier 224 may obtain or identify a signal provider(s) to identify a logical predicate. In particular, in embodiments, the logical predicate identifier 224 may obtain or identify a signal provider(s) relevant to a requirement for which evaluator logic is being generated. For example, based on an obtained requirement, one or more signal providers corresponding with the requirement may be obtained from a data store, such as signal providers 214C of data store 214. In some cases, a signal provider may be identified as relevant to a requirement based on analysis of the requirement. For example, for a requirement that references speed, one or more signal providers related to speed may be identified and obtained.

In one implementation, AI technology 260, such as an LLM, may be used to identify that a signal provider(s) is relevant to a particular requirement. For example, based on a prompt including a requirement, an LLM may provide, as output, one or more signal providers relevant to the requirement. In some cases, a response including a relevant signal provider(s) may be generated using the pre-trained knowledge or data of an LLM. In other cases, such a response may be generated using the pre-trained knowledge of the LLM as well as relevant data searched for and obtained via a data store (e.g., via a RAG retrieval mechanism). For example, based on a requirement included in a prompt, one or more relevant signal providers may be searched for and obtained from signal providers 214C of data store 214. The signal providers 214C of data store 214 may be obtained at the data store in any number of ways. For example, an individual, such as a developer, may generate or provide signal providers for storage in data store 214. As another example, signal providers may be generated in association with a prior requirement analysis or evaluator logic generation and, thereafter, stored as signal providers 214C in the data store 214.

In some embodiments, a signal provider(s) may be generated. A signal provider(s) may be generated in any of a number of ways. As one example, a signal provider may be automatically generated based on analysis of log data read (e.g., via a reader, such as an AVMF reader). For instance, data may be extracted from logs (e.g., log data 284 included as input data 280) and, thereafter, used to identify or generate a corresponding signal provider. For example, assume a requirement includes an aspect related to jerk of a vehicle. In such a case, acceleration data in logs may be identified as relevant to jerk and, as such, used to generate a signal provider to represent jerk.

In accordance with identifying a signal provider(s) relevant to a requirement, the signal provider(s) may be used to generate a corresponding logical predicate. In some cases, a logical predicate may be generated in a manner that, when applied to output from a signal provider, results in output in a Boolean form. For example, for a signal generator that provides speed, a logical predicate may be generated that provides output indicating whether the speed exceeds a threshold speed (e.g., 2 miles per hour). To construct a logical predicate using or based on a signal provider, a logical or Boolean condition may be applied that transforms numerical or continuous values provided by a signal provider to Boolean or binary values. In this way, the logical predicate may include a logical condition or comparison applied to a signal(s) output from a signal provider that transforms numerical or continuous values of the signal provider into Boolean values, for example, a Boolean time series indicating whether the condition is met at each point in time. In this regard, a condition or comparison for signal provider values may be defined. Such conditions may include, for example, threshold crossing if the signal exceeds or falls below a specific value, a verification of whether the signal provider value equals or does not equal a particular value, etc. A condition or comparison used for generating a logical predicate may be based on the requirement. For example, propositional statements in the requirement may be identified and used to generate a logical predicate that provides Boolean output.

Alternatively or additionally to generating logical predicates (e.g., via signal providers identified as relevant to a requirement), in some cases, the logical predicate identifier 224 may identify logical predicates via logical predicates 214E of data store 214. In this regard, based on a requirement, a logical predicate(s) relevant to the requirement may be obtained from the data store 214. For example, a query or lookup approach may be used to identify one or more logical predicates relevant to a requirement. As another example, AI technology 260, such as an LLM, may be used to identify one or more logical predicates relevant to the requirement. For example, based on a prompt including a requirement, the LLM may provide, as output, one or more logical predicates relevant to the requirement. In some cases, a response including a relevant logical predicate(s) may be generated using the pre-trained knowledge or data of an LLM. In other cases, such a response may be generated using the pre-trained knowledge of the LLM as well as relevant data searched for and obtained via a data store (e.g., via a RAG retrieval mechanism). For example, based on a requirement included in a prompt, one or more relevant logical predicates may be searched for and obtained from logical predicates 214E of data store 214.

Logical predicates 214 may be obtained at data store 214 in any number of ways. As one example, logical predicates may be automatically generated based on a previous evaluator logic generation and, thereafter, stored in data store 214 as logical predicates 214E. As another example, a developer or expert may generate various logical predicates 214E, which may be stored in data store 214 for use in subsequent generation of evaluator logic. The logical predicate identifier 224 may identify any number of logical predicates in association with a requirement. For example, five logical predicates may correspond with a particular requirement obtained by the requirement obtainer 222.

The logical formula identifier 226 is generally configured to identify a logical formula for the requirement. A logical formula generally refers to an expression (e.g., formal expression) that includes logical predicates that represent variables, statements, or propositions and, in many cases, operators that combine or relate propositions to form a more complex formula. The logical predicate may be represented or denoted in any number of ways, one example of which includes letters representing a logical predicate. Operators may be any symbol or text that represents an operation or relationship. Operators may include logical operators, temporal operators, spatial operators, spatiotemporal operators, and/or relational operators. Logical operators generally connect and/or modify propositions. Some examples of logical operators include “˜” representing negation, “∧” representing conjunction, “v” representing “or”, → representing implication (e.g., if . . . then), ←→ representing biconditional (e.g., if and only if), etc. Additionally, temporal operators may be used. Temporal operators generally incorporate or consider the change of propositions over time. In this regard, temporal operators enable a truth value of a proposition to change at different times. Some example of temporal operators include F for future (e.g., eventually a P will become true at some future point), G for globally (e.g., Always P or P is true for all future times), X for next (e.g., “Next P” or P will be true at the next moment in time, U for until (e.g., “P until Q” or P holds until Q becomes true), etc. Further, relational operators that compare signal values (e.g., <, >, etc.) may be used to generate a logical formula.

Based on a requirement, the logical formula identifier 226 may combine or aggregate various logical predicates, operators, and/or parameters in a manner that logically formalizes the requirement. Various types of logic may be used to formalize the requirement into a logical formula. For example, a temporal logic, such as STL, may be used. Generally, STL may combine temporal operators with signals or continuous behaviors of time, thereby enabling expression of properties of signals that evolve over time (e.g., speed, temperature, etc.). In this regard, STL logical formulas may be constructed using logical operators and/or temporal operators with time bounds or parameters that restrict when certain conditions are evaluated or applied.

As such, in embodiments, the logical formula identifier 226 may use time parameters or other parameters to generate a logical formula (e.g., in addition to logical predicates and operators). In some embodiments, a parameter(s) may restrict or indicate when to apply certain conditions. As one example, a performance metric related to the timing of system responses may be used. For instance, a vehicle abstraction layer (VAL) latency measures the delay between the input to the VAL and the output generated after processing that input. Another example of a parameter may include a time range within which certain conditions are evaluated.

Operators and/or parameters may be identified for use in generating a logical formula in any number of ways. In some cases, the logical formula identifier 224 may identify an operator(s) and/or parameter(s) via operators and parameters 214D of data store 214. Operators and parameters 214D may be obtained in data store 214 in any number of ways. For example, an operator(s) and/or parameter(s) may be automatically generated based on a previous evaluator logic generation and, thereafter, stored in data store 214 as an operator and/or parameter 214D. As another example, a developer or expert may generate various operators and parameters, which may be stored as operators and parameters 214D in data store 214 for use in subsequent generation of evaluator logic. In some cases, operators and/or parameters may be a pre-defined set of existing STL operators or parameters. In this regard, based on a requirement, an operator(s) and/or parameter(s) relevant to the requirement may be obtained from the data store 214. For example, a query or lookup approach may be used to identify one or more operators and/or parameters relevant to a requirement. As another example, AI technology 260, such as an LLM, may be used to identify one or more operators and/or parameters relevant to a requirement and a manner in which to use the operators or parameters in relation to a logical predicate(s). As one example, AI may use existing logical formulas from other evaluator logics to identify reusable patterns for the logical formula to be generated. In other cases, an operator and/or parameter may be identified based on analysis of the requirement (e.g., using AI technology or other technology).

In some cases, AI technology 260, such as an LLM, may be used to generate a logical formula. In this way, the logical formula identifier 226 may include, or access, an LLM that provides output of a logical formula. Input to the LLM may include, for example, a requirement, a set of logical predicates (e.g., logical predicates identified via logical predicate identifier 224), a set of operators (e.g., logical operators, temporal operators, relational operators, for example, accessed via a data store 214), a set of parameters (e.g., accessed via data store 214) an instruction to generate a logical formula, and/or the like. In this regard, the logical formula identifier 226 may generate a prompt that includes a requirement, a set of logical predicates, a set of operators, a set of parameters, and/or an instruction and, thereafter, provide the prompt as input to the AI technology 260. In response, the AI technology 260 may return a logical formula that more formally represents a particular requirement.

Additionally or alternatively, AI technology 260, such as an LLM may access a data store, such as data store 214, to generate a response. For instance, a prompt may include an instruction to generate a logical formula for a particular requirement. Various data, such as the logical predicates, operators, and/or parameters, may not be provided in the prompt. In this regard, an LLM may employ retrieval-augmented generation (RAG) to enable access to a data store including various logical predicates, operators, and/or parameters to generate a response. In this way, a retrieval mechanism may be employed with the LLM to search and fetch relevant data from the data store, such as relevant logical predicates, operators, and/or parameters for use in generating a logical formula. As such, a generated response is prepared based on the pre-trained knowledge of the LLM and the retrieved data.

In some examples, the generated logical formula may be verified. For instance, a logical formula represented using temporal logic (e.g., STL) enables a human or technology to verify the correctness. As such, the generated logical formula may be presented via a display to enable verification of the logical formula. In this way, various iterations to generate the logical formula may be employed based on user feedback. Such a verification may facilitate reduction of errors and provide a more accurate output generated by an LLM or generative language model.

The evaluator logic generator 228 is generally configured to generate evaluator logic in association with a requirement. As described, evaluator logic generally refers to logical structures or rules embedded to evaluate specific conditions or expressions to determine an outcome. In embodiments, evaluator logic may be in an executable format, such as Python. In this way, the evaluator logic may be executed (e.g., based on a call) to evaluate a product, system, or technology.

In embodiments, to generate evaluator logic, the evaluator logic generator 228 may convert a logical formula associated with a requirement into an executable code format (e.g., Python). In this regard, the evaluator logic generator 228 may parse a logical formula generated by logical formula identifier 226, map components to expressions associated with the code format (e.g., Python), and implement the logic in an executable manner. As one example, a logical formula may be parsed into various operators (e.g., logical operators and temporal operators). In addition, other components, such as conditions or time intervals or signal providers, may also be parsed. The components may be mapped or defined for translating into the target code language (e.g., Python).

In some embodiments, AI technology 260, such as an LLM, may be used to generate evaluator logic for a requirement based on a logical formula. As one example, an LLM may interpret an input logical formula and identify various components of the logical formula (e.g., logical predicates, parameters, operators, etc.). Upon performing a mapping to the target coding language (e.g., Python), the evaluator logic is created by the LLM, for example, by writing functions to evaluate conditions, creating loops to iterative over time intervals specified in logical formula, etc.

In this way, the evaluator logic generator 228 may include, or access, an LLM that provides output of a logical formula. Input to the LLM may include, for example, a requirement, a set of logical predicates (e.g., logical predicates identified via logical predicate identifier 224), a set of operators (e.g., logical operators, temporal operators, relational operators, for example, accessed via a data store 214), a set of parameters (e.g., accessed via data store 214), a logical formula, a target coding language, an instruction to generate an evaluator logic, and/or the like.

In this regard, in some cases, the evaluator logic generator 228 may generate a prompt that includes a requirement, a set of logical predicates, a set of operators, a set of parameters, a logical formula, a target coding language, and/or an instruction and, thereafter, provide the prompt as input to the AI technology 260. In response, the AI technology 260 may return evaluator logic that may be executed to evaluate or analyze a product, system, or technology in association with a particular requirement.

Additionally or alternatively, AI technology 260, such as an LLM, may access a data store, such as data store 214, to facilitate generation of a response. For instance, a prompt may include an instruction to generate an evaluator logic for a particular requirement. Further, such a prompt may include an identified logical formula and/or a target coding language for generating the evaluator logic. Various data, such as the logical predicates, operators, and/or parameters may not be provided in the prompt, but rather accessed via a data store (e.g., using RAG technique), as needed. As one example, the evaluator logic generator 228 may generate a prompt that includes the logical formula such that the evaluator logic may be generated therefrom and a target coding language in which to generate the evaluator logic. In some cases, a template may be accessed and used to generate the evaluator logic. For example, a template may be identified and included in a prompt for use in generating the evaluator logic. In response to the prompt, the AI technology may generate an evaluator logic for use in evaluating or analyzing a product, system, or technology.

In some cases, the AI technology 260, such as an LLM, may be used in an iterative manner to perform the various aspects. For example, an LLM may be fed a first prompt to identify relevant signal providers, a second prompt to identify relevant logical predicates, a third prompt to identify a logical formula, and a fourth prompt to generate evaluator logic, or any combination thereof. In other cases, an LLM may be used in a single implementation to perform the various aspects of the evaluator logic generation. In this regard, a single prompt may be generated and provided to an LLM to generate an evaluator logic. In such a case, the LLM may facilitate performance of the various aspects to generate the evaluator logic. The single prompt may be configured to include various types of data. In one example, the prompt may include a requirement and a request to generate an evaluator logic. In this regard, the LLM can convert or transform the requirement (e.g., in a natural language format) to an executable evaluator logic, as described herein. In such a case, additional data used to generate the evaluator logic may be obtained via an embedded search (e.g., logical predicates, signal providers, operators, parameters, etc.). In another example, the prompt may additionally include various additional types of data, such as signal providers, operators, parameters, logical predicates, etc.

In some embodiments, the AI technology 260, such as an LLM, may be fine-tuned to facilitate generation of a more efficient and accurate evaluation results. In some embodiments, an LLM to fine-tune may be a pre-trained model. To perform fine-tuning of a model (e.g., a pre-trained model), data may be collected for performing fine-tuning. Data collected may include annotated code, domain-specific documents, and STL formulas, etc. Annotated code may include code snippets associated with signal names, APIs, and requirements (e.g., VLRs). Domain-specific documents may include technical documents, requirements specifications, protocol buffers definitions (also referred to as Protobuf definitions), and formal language descriptions. STL formulas may include examples of STL formulas used in AVs.

In accordance with collecting data, the data may be preprocessed. Preprocessing the data may include cleaning data, tokenization, and annotation. Cleaning data may include removing any irrelevant or noisy data and normalizing text formats to maintain consistency. Tokenization may include tokenizing the collected data, such as the domain-specific language elements and the requirements. Annotation may include labeling data with relevant information such as signal names, logical predicates, and their relations. In addition, metadata tags may be created or collected for different components (e.g., signal provider, logical predicates). For example, data may be labeled as a signal provider, a logical predicate, raw data, etc.

To perform fine-tuning, training configuration data are defined, selected, or input. For example, hyperparameters, such as learning rate, batch size, number of epochs, etc., may be defined. As another example, a suitable optimization algorithm (e.g., AdamW) may be selected. A training loop may then be employed to fine-tune the model in accordance with the training configuration data. In this regard, the preprocessed data may be loaded into the model, and a training loop may be performed that iteratively updates model weights based on loss calculated from predictions versus actual annotations. Iteratively updating of model weights may proceed, for example, until the predictions converge to or approximate the training data based on the loss function. The model may then be validated to evaluate model performance on a validation set of data to prevent overfitting. In addition, post-training evaluation may be performed on a separate test dataset to assess performance of the fine-tuned model. For example, domain-specific metrics may be used to assess performance, such as accuracy in logical formula generation, signal provider identification, logical predicate identification, etc. In cases in which common errors are identified, the dataset and annotations may be refined based on this analysis and used for further fine-tuning.

In generating an evaluator logic, in some cases, the evaluator logic may be stored as evaluator logic 214G in data store 214. In this way, the evaluator logic may be subsequently referenced and/or used. Additionally or alternatively, the evaluator logic may be incorporated into analysis manager 240 such that it may be called to analyze a product, system, and/or technology. Further, in some cases, the evaluator logic may be provided for display via a user interface. For example, a generated evaluator logic may be presented to a product developer (e.g., that requested generation of an evaluator logic). The product developer may then review or analyze the evaluator logic, for example, to determine whether to implement or execute the evaluator logic. In some cases, in addition to presenting evaluator logic, other data may be presented, such as logical predicates, signal providers, logical formula, etc. used to generate the evaluator logic.

In some embodiments, evaluator logic analyzer 230 may be used to analyze generated evaluator logic, such as evaluator logic generated by evaluator logic generator 228. In this regard, upon the evaluator logic generator 228 generating evaluator logic in association with a requirement, the evaluator logic analyzer 230 may facilitate analysis of the evaluator logic. As can be appreciated, analyzing evaluator logic generally facilitates verification and/or validation of an effective or accurate evaluator logic.

In some cases, to analyze the evaluator logic, the evaluator logic analyzer 230 may communicate with the analysis manager 240 to obtain evaluation results using the evaluator logic. For example, the evaluator logic analyzer 230 may provide log data, and other applicable data, to the analysis manager 240 to initiate analysis of the evaluator logic. In this regard, the analysis manager 240 may execute the evaluator logic using, for example, log data, as described more fully below. The evaluation results generated via the analysis manager 240 may be returned to the evaluator logic analyzer 230, which can then facilitate assessment of the quality or accuracy of the evaluation results. In some cases, the evaluator logic analyzer 230 may assess the quality or accuracy. Alternatively or additionally, the evaluator logic analyzer 230 may present the evaluation results to a user, such as a developer via a user interface, to review for accuracy of the evaluation results.

In other cases, to analyze the evaluator logic, the evaluator logic analyzer 230 may include or access AI technology, such as AI technology 260. As one example, the evaluator logic analyzer 230 may generate a prompt requesting assessment of the quality or accuracy of the evaluator logic. The prompt may be input into the AI technology 260, such as an LLM, and, in response, an analysis of the evaluator logic may be provided. In some examples, the evaluator logic analysis may be provided, for example, for display to a user device. In such a case, the user may elect to confirm or deny subsequent use of the evaluator logic.

As another example, the evaluator logic analyzer 230 may facilitate interaction between a user and the LLM to perform analysis of evaluator logic. For example, via an input tool at a user device, a user may provide an input with an instruction or request to provide shortcomings or issues of an evaluator logic, provide a quality assessment of an evaluator logic, and/or the like. The evaluator logic analyzer 230 may generate a corresponding prompt based on the input and the evaluator logic for providing to the AI technology 260. The AI technology may then provide a response to the evaluator logic analyzer 230, which may then be further analyzed, used to enhance the previously generated evaluator logic, and/or provided for display (e.g., to a user via a user device).

Turning now to the analysis manager 240, the analysis manager 240 is generally configured to manage analysis of a product, system, and/or technology. In particular, the analysis manager 240 may use an evaluator logic to analyze or evaluate a product, system, and/or technology. Analysis of a product, system, and/or technology may be implemented in any number of environments. For example, a product, system, and/or technology (e.g., AV system, or portion thereof) may be analyzed in connection with a requirement(s) during product development, verification, validation, and/or implementation.

Analyzing a product, system, and/or technology using an evaluator logic(s) may be initiated in any of a number of ways. As one example, a user of a user device (e.g., a product developer) may select to execute or run a particular evaluator logic to evaluate a particular product in association with a requirement. For instance, a user may select or input to evaluate a particular product in association with a particular requirement.

As another example, a user of a user device may select to execute or run a test to analyze a particular product. A test generally refers to a procedure or process used to evaluate the functionality, performance, or behavior of a product, system, and/or technology. A test may be used to verify various requirements are attained. In this way, a test facilitates identification of issues, ensures reliability, and/or validates that the product, system, or technology operates as intended. A test may include a coverage plan that specifies conditions or manners in which to execute a test. For example, for an AV coverage plan, the test may include driving conditions, different road scenarios, times and durations, etc. A test may correspond with any number of requirements. For instance, for a test to ensure AV safety, various requirements may need to be met in the various testing conditions.

In other cases, analysis of a product, system, and/or technology may be automatically initiated. For example, as a set of log data, or derivations associated therewith (e.g., via a signal provider or logical predicate) is obtained, analysis of a requirement(s) associated therewith may be automatically initiated.

To analyze a product, system, and/or technology in association with a requirement, the analysis manager 240 may obtain a representation of data to be analyzed in association with a requirement. The data representation may be any type of data associated with a requirement. For example, for VLR requirements, AV data may be obtained. In embodiments, the data may be observed data (e.g., via an actual or real drive process) or simulated data. In this way, performance or operation of a product, system, or technology may be analyzed in relation to a requirement with actual observed data or, alternatively or additionally, with simulated data or synthetic data.

In some cases, the representation of data may be in the form of log data. In this way, the analysis manager 240 may obtain log data, such as log data generated via an AV. In other cases, the representation of data may be in the form of an output generated via a signal provider(s) and/or logical predicate(s). For instance, the representation of data may be or include a time series dataset based on application of a signal provider(s) and/or logical predicate(s) to log data (e.g., observed log data and/or simulated log data). By way of example only, a signal provider may obtain log data by way of a reader. The signal provider may perform a corresponding processing of the log data to generate a signal that is obtained at the analysis manager 240.

In accordance with initiating analysis of a product, system, and/or technology in relation to a requirement(s), the analysis manager 240 may reference or call the evaluator logic(s) that corresponds with the requirement(s) to execute the evaluator logic(s). In this way, the evaluator logic(s) may execute the logical formula, given a set of signal providers, logical predicates, and/or parameters, to produce an evaluation result. In executing the evaluator logic(s), the evaluator logic may reference, access, or fetch various types of data to perform the evaluation. For example, the evaluator logic may reference log data, signal providers, signals generated from signal providers, logical predicates, operators, parameters, logical formulas, and/or the like.

The evaluation results generated based on execution of the evaluator logic may be represented in any form. As one example, a pass or fail result may be represented (e.g., via text, numerals, symbols, etc.) in association with a corresponding requirement. In some cases, the evaluation results may correspond with an event. An event may correspond with a particular set of data. For example, for one set of log data associated with a particular AV, an evaluation result may be generated for the event.

In accordance with generating evaluations results, such evaluation results may be stored, such as evaluator results 214H in data store 214. In some cases, an evaluation result may be stored for each event. In other cases, a set of events identified as meeting the requirement may be stored and a separate set of events identified as failing the requirement may be stored.

Evaluation results provider 250 is generally configured to provide evaluation results. In some cases, evaluation results are provided to a data store or another system or component for analyzing the results. As one example, the evaluation results may be provided to a system or that analyzes the results and automatically updates or corrects the system or technology being tested in association with a requirement(s). As another example, the evaluation results may be provided for display to a user. For instance, a user that initiates generation of evaluator logic and/or evaluation of a product, system, and/or technology may be provided with the evaluation results. In accordance with reviewing the evaluation results, the user may analyze, modify, or update the product, system, and/or technology to obtain conformance with the requirement.

Evaluation results may be provided in any of a number of ways. As one example, an evaluation result may be presented for each event. In another example, a set of events identified as meeting the requirement may be presented and a separate set of events identified as failing the requirement may be presented. By way of example only, depending on a requirement being evaluated in association with a product, system, or technology, evaluation results may indicate or specify whether the data indicates a system (e.g., an AV system) is safe, whether an AV system will perform suitably if a pedestrian jumps in front, whether an AV system will reduce its speed if another vehicle on the path begins decelerating, etc. In this way, the evaluation results facilitate evaluation of a product, system, or technology to ensure or verify the technology operates as intended or desired.

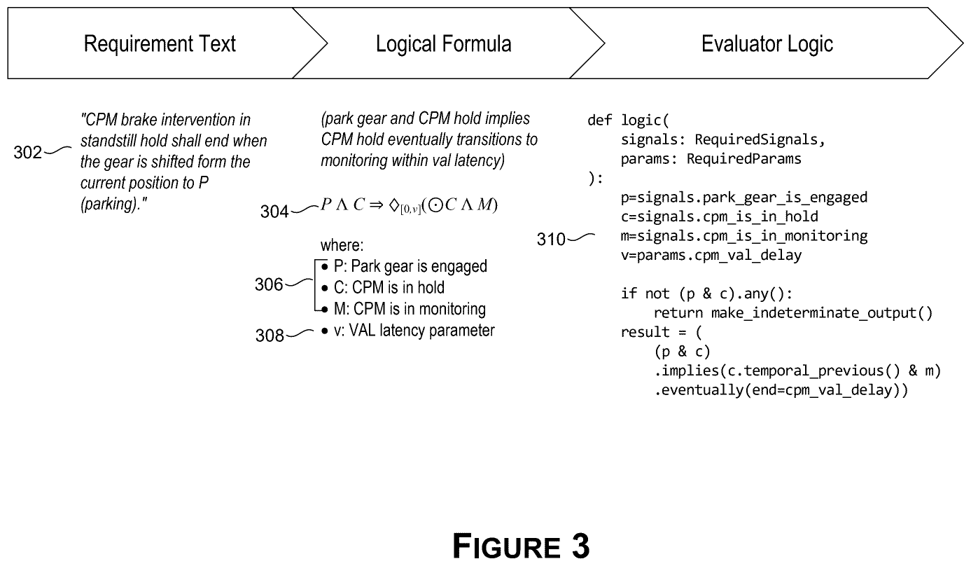

Turning to FIG. 3, FIG. 3 provides an example for generating evaluator logic. In FIG. 3, a requirement 302 is initially obtained. In this example, the requirement is in the form of a VLR. Based on the requirement 302, a logical formula 304 is generated. To generate the logical formula 304, logical predicates 306 and parameter 308 may be identified. For example, for the logical predicates 306, a signal P that indicates a park gear is engaged, a signal C that indicates if CPM is in hold, and a signal M that indicates CPM is in monitoring may be identified. For a parameter, a parameter v that indicates when latency is acceptable may be identified. In accordance with identifying logical predicates 308 and parameter 308, the logical formula 304 (e.g., in STL form) may be generated. Thereafter, evaluator logic 310 may be generated, for example, using an LLM.

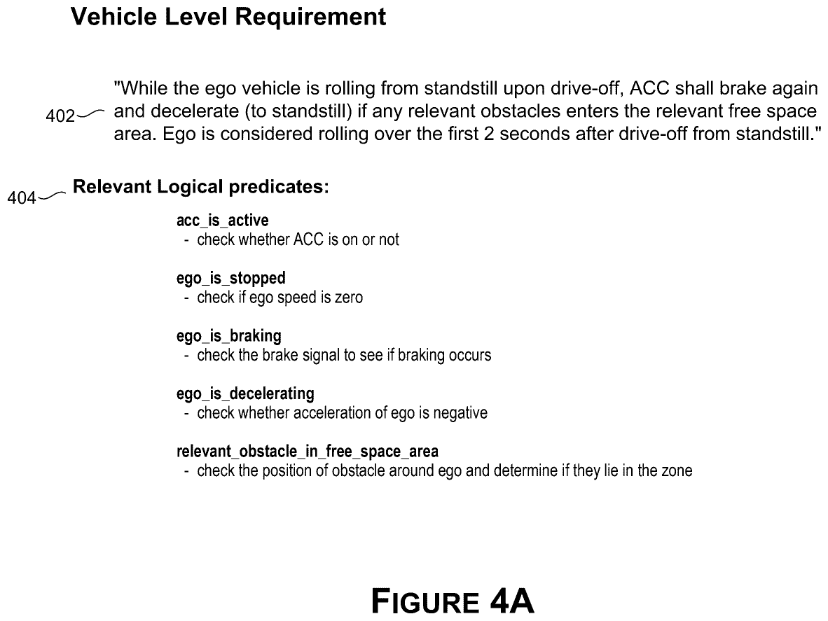

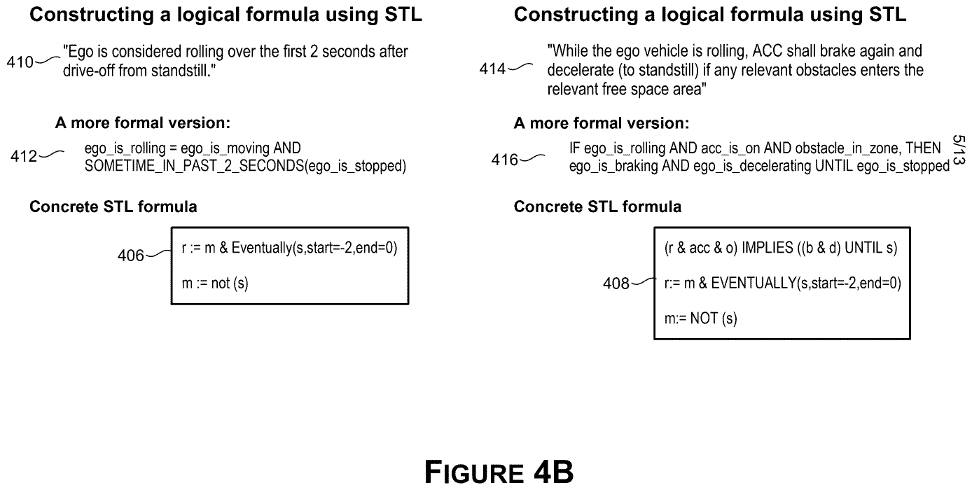

As another example, FIGS. 4A-4B provide an example for generating a logical formula, in accordance with embodiments described herein. As shown in FIG. 4A, a requirement 402 in the form of a VLR is obtained. Logical predicates 404 relevant to the requirement 402 may be identified. Thereafter, as shown in FIG. 4B, logical formulas 406 and 408 may be generated in the form of STL. In some cases, constructing a logical formula, for example in STL, may include an intermediary version between a requirement and the logical formula. For example, for the portion 410 of the requirement 402, a more formal version 412 may be created to generate the logical formula 406. Similarly, for the portion 414 of the requirement 402, a more formal version 416 may be created to generate the logical formula 408. The logical formulas 406 and 408 may be used to create an evaluation logic in the STL language (e.g., using an LLM).

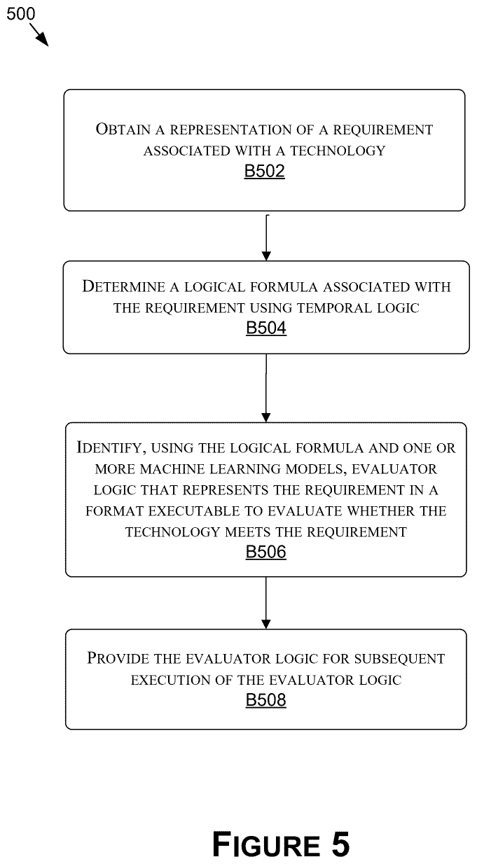

Now referring to FIGS. 5-7, each block of methods 500, 600, and 700 described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, methods 500, 600, and 700 are described, by way of example, with respect to the system of FIG. 1 and FIG. 2. However, this method may additionally or alternatively be executed by any one system, or any combination of systems, including, but not limited to, those described herein.

FIG. 5 is a flow diagram showing a method 500 for facilitating management of evaluator logic, in accordance with some embodiments of the present disclosure. The method 500, at block B502, includes obtaining a representation of a requirement associated with a technology. In embodiments, a requirement is in the form of a VLR. In some cases, a requirement may be obtained via a user interface of a user device. In other cases, a requirement may be obtained via a data store.

The method 500, at block B502, includes determining a logical formula associated with the requirement using temporal logic. In some cases, a logical formula may be determined by identifying, using the machine learning model(s), a logical predicate associated with the requirement. Logical predicate identification may occur, for example, by identifying a signal provider associated with the requirement and using the signal provider to identify the logical predicate. Thereafter, a logical formula associated with the requirement is determined (e.g., using the machine learning model(s)). In embodiments, the logical formula may be determined by identifying a temporal operator associated with the requirement and aggregating the logical predicate with the temporal operator using a STL format.

The method 500, at block B504, includes identifying, the logical formula using one or more machine learning models, evaluator logic that represents the requirement in a format executable to evaluate whether the technology meets the requirement. As described, the logical formula may be used to generate the evaluator logic. For example, an LLM may be used, with the logical formula provided as a prompt input into the LLM, and the evaluator logic provided as an output.

The method 500, at block B506, includes providing the evaluator logic for subsequent execution of the evaluator logic. In some embodiments, the evaluator logic may be presented for display and/or analyzed to validate the evaluator logic.

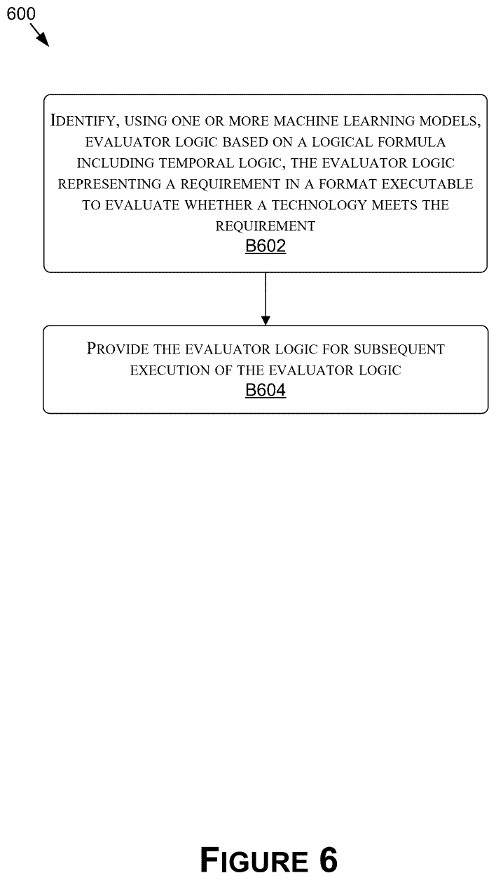

FIG. 6 provides a flow diagram showing a method 600 for facilitating management of evaluator logic, in accordance with some embodiments of the present disclosure. The method 600, at block B602, includes identifying, using one or more machine learning models, evaluator logic based on a logical formula including temporal logic, the evaluator logic representing a requirement in a format executable to evaluate whether a technology meets the requirement. In some cases, the logical formula may be generated by aggregating a set of logical predicates with a set of operators (e.g., including at least one temporal operator). The evaluator logic may be identified in any number of ways. As one example, evaluator logic may be identified by inputting a prompt into an LLM to identify the evaluator logic in association with the requirement and obtaining, in response to the prompt, the evaluator logic representing the requirement in the format executable to evaluate whether the technology meets the requirement.

The method 600, at block B604, includes providing the evaluator logic for subsequent execution of the evaluator logic. In some cases, the evaluator logic may be displayed. A user may then confirm to use the evaluator logic to analyze the technology in association with the requirement.

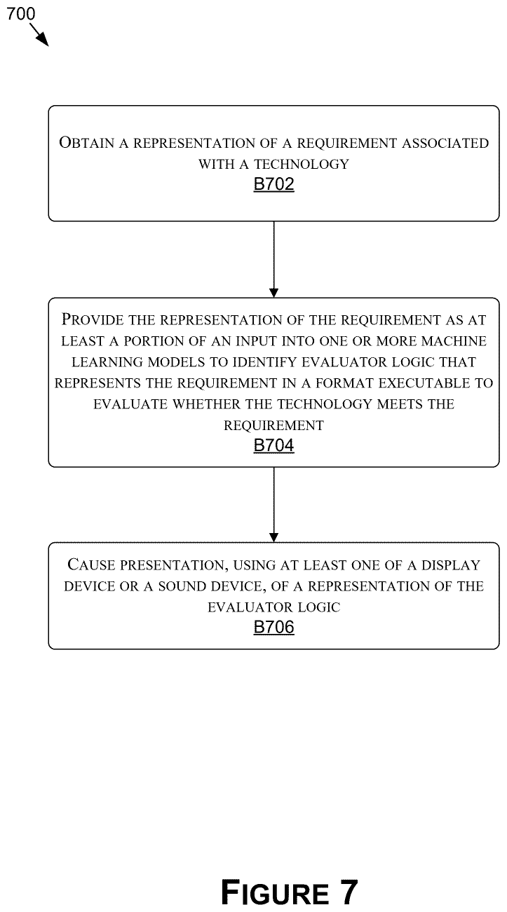

Turning to FIG. 7, FIG. 7 provides a flow diagram showing a method 700 for facilitating management of evaluator logic, in accordance with some embodiments of the present disclosure. The method 700, at block B702, includes obtaining a representation of a requirement associated with a technology.

The method 700, at block B704, includes providing the representation of the requirement as at least a portion of an input into one or more machine learning models to identify evaluator logic that represents the requirement in a format executable to evaluate whether the technology meets the requirement. In some cases, the input includes a prompt to provide to an LLM. The representation of the requirement may be in any number of formats. As one example, the representation of the requirement may include a user input text description of the requirement. As another example, the representation of the requirement may include a logical formula, including logical predicates, logical operators, and/or parameters.

The method 700, at block B706, includes causing presentation, using at least one of a display device or a sound device, of a representation of the evaluator logic. In this way, the evaluator logic is presented to a user.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, aid in collaboration or team efforts among teams, and/or personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type - including but not limited to those described herein - may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 8A is a block diagram of an example generative language model system 800 suitable for use in implementing at least some embodiments of the present disclosure. In the example illustrated in FIG. 8A, the generative language model system 800 includes a retrieval augmented generation (RAG) component 892, an input processor 805, a tokenizer 810, an embedding component 820, plug-ins/APIs 895, and a generative language model (LM) 830 (which may include an LLM, a VLM, a multi-modal LM, etc.).

At a high level, the input processor 805 may receive an input 801 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 830 (e.g., LLM/VLM/MMLM/etc.). In some embodiments, the input 801 includes plain text in the form of one or more sentences, paragraphs, and/or documents. Additionally or alternatively, the input 801 may include numerical sequences, precomputed embeddings (e.g., word or sentence embeddings), and/or structured data (e.g., in tabular formats, JSON, or XML). In some implementations in which the generative LM 830 is capable of processing multi-modal inputs, the input 801 may combine text (or may omit text) with image data, audio data, video data, design data, USD data, and/or other types of input data, such as but not limited to those described herein. Taking raw input text as an example, the input processor 805 may prepare raw input text in various ways. For example, the input processor 805 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 805 may remove stopwords to reduce noise and focus the generative LM 830 on more meaningful content. The input processor 805 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 892 (which may include one or more RAG models, and/or may be performed using the generative LM 830 itself) may be used to retrieve additional information to be used as part of the input 801 or prompt. RAG may be used to enhance the input to the LLM/VLM/MMLM/etc. with external knowledge, so that answers to specific questions or queries or requests are more relevant—such as in a case where specific knowledge is required. The RAG component 892 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 801 may be generated using the query or input to the model (e.g., a question, a request, etc.) in addition to data retrieved using the RAG component 892. In some embodiments, the input processor 805 may analyze the input 801 and communicate with the RAG component 892 (or the RAG component 892 may be part of the input processor 805, in embodiments) in order to identify relevant text and/or other data to provide to the generative LM 830 as additional context or sources of information from which to identify the response, answer, or output 890, generally. For example, where the input indicates that the user is interested in a desired tire pressure for a particular make and model of vehicle, the RAG component 892 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 892 may retrieve a prior stored conversation history—or at least a summary thereof—and include the prior conversation history along with the current ask/request as part of the input 801 to the generative LM 830.

The RAG component 892 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 892 and the embeddings of the chunks along with the embeddings of the query may be compared to identify the most similar/related embeddings to the query, which may be supplied to the generative LM 830 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 892 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 810 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 830 to understand morphological variations and handle out-of-vocabulary words more effectively. Character-based tokenization represents each character as a separate token, enabling the generative LM 830 to process text at a fine-grained level. The choice of tokenization strategy may depend on factors such as the language being processed, the task at hand, and/or characteristics of the training dataset. As such, the tokenizer 810 may convert the (e.g., processed) text into a structured format according to tokenization schema being implemented in the particular embodiment.

The embedding component 820 may use any known embedding technique to transform discrete tokens into (e.g., dense, continuous vector) representations of semantic meaning. For example, the embedding component 820 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 801 includes image data/video data/etc., the input processor 801 may resize the data to a standard size compatible with format of a corresponding input channel and/or may normalize pixel values to a common range (e.g., 0 to 1) to ensure a consistent representation, and the embedding component 820 may encode the image data using any known technique (e.g., using one or more convolutional neural networks (CNNs) to extract visual features). In some implementations in which the input 801 includes audio data, the input processor 801 may resample an audio file to a consistent sampling rate for uniform processing, and the embedding component 820 may use any known technique to extract and encode audio features—such as in the form of a spectrogram (e.g., a mel-spectrogram). In some implementations in which the input 801 includes video data, the input processor 801 may extract frames or apply resizing to extracted frames, and the embedding component 820 may extract features such as optical flow embeddings or video embeddings and/or may encode temporal information or sequences of frames. In some implementations in which the input 801 includes multi-modal data, the embedding component 820 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 830 and/or other components of the generative LM system 800 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 820 may apply an encoded representation of the input 801 to the generative LM 830, and the generative LM 830 may process the encoded representation of the input 801 to generate an output 890, which may include responsive text and/or other types of data.

As described herein, in some embodiments, the generative LM 830 may be configured to access or use—or capable of accessing or using—plug-ins/APIs 895 (which may include one or more plug-ins, application programming interfaces (APIs), databases, data stores, repositories, etc.). For example, for certain tasks or operations that the generative LM 830 is not ideally suited for, the model may have instructions (e.g., as a result of training, and/or based on instructions in a given prompt, such as those retrieved using the RAG component 892) to access one or more plug-ins/APIs 895 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 895 to the plug-in/API 895, the plug-in/API 895 may process the information and return an answer to the generative LM 830, and the generative LM 830 may use the response to generate the output 890. This process may be repeated—e.g., recursively—for any number of iterations and using any number of plug-ins/APIs 895 until an output 890 that addresses each ask/question/request/process/operation/etc. from the input 801 can be generated. As such, the model(s) may not only rely on its own knowledge from training on a large dataset(s) and/or from data retrieved using the RAG component 892, but also on the expertise or optimized nature of one or more external resources—such as the plug-ins/APIs 895.

FIG. 8B is a block diagram of an example implementation in which the generative LM 830 includes a transformer encoder-decoder. For example, assume input text such as “Who discovered gravity” is tokenized (e.g., by the tokenizer 810 of FIG. 8A) into tokens such as words, and each token is encoded (e.g., by the embedding component 820 of FIG. 98A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 835 of the generative LM 830.

In an example implementation, the encoder(s) 835 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 840 may convert the context vector into attention vectors (keys and values) for the decoder(s) 845.

In an example implementation, the decoder(s) 845 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 835, in an example transformer architecture, each token (e.g., word) flows through a separate path in the decoder(s) 845. During a first pass, the decoder(s) 845, a classifier 850, and a generation mechanism 855 may generate a first token, and the generation mechanism 855 may apply the generated token as an input during a second pass. The process may repeat in a loop, successively generating and adding tokens (e.g., words) to the output from the preceding pass and applying the token embeddings of the composite sequence with positional encodings as an input to the decoder(s) 845 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 835, except that it creates its queries from the layer below it and takes the keys and values (e.g., matrix) from the output of the encoder(s) 835.

As such, the decoder(s) 845 may output some decoded (e.g., vector) representation of the input being applied during a particular pass. The classifier 850 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 855 may select or sample a word or token based on a corresponding predicted probability (e.g., select the word with the highest predicted probability) and append it to the output from a previous pass, generating each word or token sequentially. The generation mechanism 855 may repeat the process, triggering successive decoder inputs and corresponding predictions until selecting or sampling a symbol or token that represents the end of the response, at which point, the generation mechanism 855 may output the generated response.

FIG. 8C is a block diagram of an example implementation in which the generative LM 830 includes a decoder-only transformer architecture. For example, the decoder(s) 860 of FIG. 8C may operate similarly as the decoder(s) 845 of FIG. 8B except each of the decoder(s) 860 of FIG. 8C omits the encoder-decoder self-attention layer (since there is no encoder in this implementation). As such, the decoder(s) 860 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 860. As with the decoder(s) 845 of FIG. 8B, each token (e.g., word) may flow through a separate path in the decoder(s) 860, and the decoder(s) 860, a classifier 865, and a generation mechanism 870 may use auto-regression to sequentially generate one token at a time until predicting a symbol or token that represents the end of the response. The classifier 865 and the generation mechanism 870 may operate similarly as the classifier 850 and the generation mechanism 855 of FIG. 8B, with the generation mechanism 870 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). As such, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that allow the computing device 900 to communicate with other computing devices via an electronic communication network, included wired and/or wireless communications. The communication interface 910 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may allow the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that allow detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to allow the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may use distributed file system 1038 for large-scale data processing (e.g., “big data”). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
obtain a representation of a requirement associated with a technology;
determine a logical formula associated with the requirement using temporal logic;
identify, using the logical formula and one or more machine learning models, evaluator logic that represents the requirement in a format executable to evaluate whether the technology meets the requirement; and
provide the evaluator logic for subsequent execution of the evaluator logic.

2. The one or more processors of claim 1 further configured to cause presentation, using at least one of a display device or a sound device, of a representation of the evaluator logic that represents the requirement.

3. The one or more processors of claim 1 further configured to analyze the evaluator logic using the one or more machine learning models to validate the evaluator logic.

4. The one or more processors of claim 1, wherein the identifying the logical formula comprises:
identifying, using the one or more machine learning models, a logical predicate associated with the requirement; and
determining, using the one or more machine learning models, the logical formula associated with the requirement based at least on the logical predicate associated with the requirement.

5. The one or more processors of claim 4, wherein the identifying the logical predicate comprises:
identifying a signal provider associated with the requirement; and
using the signal provider associated with the requirement to identify the logical predicate.

6. The one or more processors of claim 4, wherein the determining the logical formula comprises:
identifying a temporal operator associated with the requirement; and
aggregating the logical predicate with the temporal operator using a signal temporal logic format.

7. The one or more processors of claim 1, wherein the identifying the evaluator logic includes using a template to generate the evaluator logic.

8. The one or more processors of claim 1, wherein the identifying the evaluator logic comprises:
generating a prompt for inputting to the one or more machine learning models; and
obtaining, in response to the prompt, the evaluator logic.

9. The one or more processors of claim 8, wherein the prompt includes the requirement and an instruction to generate the evaluator logic.

10. The one or more processors of claim 8, wherein the prompt includes the logical formula generated by the one or more machine learning models based on one or more logical predicates and one or more operators.

11. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

12. A system comprising one or more processors to:
identify, using one or more machine learning models, evaluator logic based on a logical formula including temporal logic, the evaluator logic representing a requirement in a format executable to evaluate whether a technology meets the requirement; and
provide the evaluator logic for subsequent execution of the evaluator logic.

13. The system of claim 12, wherein the logical formula is generated by aggregating a set of logical predicates with a set of operators including at least one temporal operator.

14. The system of claim 12, wherein the evaluator logic is identified by inputting a prompt into a large language model of the one or more machine learning models to identify the evaluator logic in association with the requirement and obtaining, in response to the prompt, the evaluator logic representing the requirement in the format executable to evaluate whether the technology meets the requirement.

15. The system of claim 12 further comprising:
cause display of the evaluator logic; and
obtain user confirmation to use the evaluator logic to analyze the technology in association with the requirement.

16. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

17. A method comprising:
obtaining a representation of a requirement associated with a technology;
providing the representation of the requirement as at least a portion of an input into one or more machine learning models to identify evaluator logic that represents the requirement in a format executable to evaluate whether the technology meets the requirement; and
causing presentation, using at least one of a display device or a sound device, of a representation of the evaluator logic.

18. The method of claim 17, wherein the input includes a prompt and the one or more machine learning models includes a large language model, and wherein the representation of the requirement comprises a user input text description of the requirement.

19. The method of claim 17 wherein the input includes a prompt and the one or more machine learning models includes a large language model, and wherein the representation of the requirement comprises a logical formula represented using a temporal logic and including one or more logical predicates, one or more operators, and/or one or more parameters.

20. The method of claim 17, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
